(19) United States
(12) Patent Application Publication
(10) Pub. No.: US 2005/0063867 A1
(43) Pub. Date: Mar. 24, 2005

(54) Fluid receptacles

(76) Inventors: Timothy Nicholas Moor, Gateshead (GB); Jonathan Redecen Dibble, Gateshead (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/496,033

(22) PCT Filed: Nov. 21, 2002
(86) PCT No.: PCT/EP02/13178

(30) Foreign Application Priority Data
Nov. 21, 2001 (GB) 0127914.0

(51) Int. Cl. B01L 3/00

(52) U.S. Cl. 422/82.05; 422/102

(57) ABSTRACT

A receptacle which may be filled with a fluid sample to be analyzed by placement into a consistent light condition environment where its temperature is measured. The bag and/or container howsoever made may be inflated by the fluid and may have a flexible or non-flexible base, a non-return valve and a fluid delivery tube, the side walls are flexible but not elastic and have high optical clarity and a cavity may or may not be provided for a thermistor due to the nature of the materials used. The receptacles may also be used in other embodiments, where via their numerous conduits, attachments and arrangements, they provide a unique flexibility and versatility in other uses and applications.

The present invention relates to fluid receptacles which may be used to retain fluids particularly for analysis and in particular it relates to receptacles that may be used in improved forms of fluid analysers capable of determining the individual chemical composition of the fluid. In our co-pending United Kingdom Patent Application 0127913.2, we describe improved fluid analyser systems. The present invention is particularly concerned with fluid receptacles that may be used in such a system.

For the purpose of this document, Fluid means:
i) Consisting of any particles that move freely among themselves.
ii) Particle means, a minute portion of matter.
iii) Matter means, any of numerous subatomic and/or atomic constituents of the physical world that interact with each other.
iv) Constituents means, anything that occupies a space.

The receptacle of the present invention is particularly useful as the container for the fluid in the fluid analyser systems described in a co-pending United Kingdom Patent Application 0127913.2.

Portable fluid analysers are known, the breathalyser used to detect alcohol in a motorist's breath is an example of a portable fluid analyser. Portable, or mobile, analysers are also used for environmental purposes such as the determination of air purity around petrochemical complexes, gas fires and boilers. Portable, or mobile analysers are also used in mining and in other hazardous activities to detect the presence of dangerous fluids.

Existing portable fluid analysers consist of a sampler and an analyser. They do however, suffer from certain disadvantages. Firstly the fluid sampler and the analyser make up a unitary apparatus with operators manning and being required to understand the complexities of the analyser. Furthermore, the results of the analysis cannot usually be compared on the spot with previous data because that is generally stored in a remote location. An additional disadvantage is that typically analysers can usually detect no more than 4 gases in a portable unit at any one time and speciality analysers can usually detect no more than 6 at any one time. The analysers are further limited in that when working on gaseous mixtures they cannot detect a concentration above and/or below a saturation limit which depends upon the nature of the gas.

Existing fluid analysers tend to detect fluids in a flow of fluid in a stream as it passes a detection probe or probes. This technique suffers from the drawback that the probe must be cleaned after each analysis before any subsequent use and it is difficult to get the probe sufficiently clean to prevent contamination for the next test. Also it is sometimes necessary to recalibrate the probes between each analysis. In many existing fluid analysers each fluid is detected through an electro chemical sensor and the user needs to replace the sensor according to the fluid to be detected. It is then necessary to recalibrate the sensor to detect another fluid.

Chemiluminescence is sometimes used for gas analysis and involves the capturing and interpretation of emitted light during a chemical reaction. Absorption and desorption rates of molecules on surfaces of fluids and their transfer rates from a surface of a fluid are dependent upon temperature. This action is termed surface diffusion and where there is an equilibrium both absorption and desorption occur creating corresponding fluxes of equal magnitude. This type of analyser suffers from the disadvantage that it relies on thermal or chemical reactions induced or otherwise to analyse the intensity values of fluids and thus determine the amounts of fluids that are present.

Gas Chromatography is also used for fluid analysis. This technique separates a mixture of fluids by passing it in solution or suspension through a medium in which the components move at different rates to enable identification of the different components present in the mixture. This suffers from the disadvantage that it is necessary to pass the sample in the container through a mixture or suspend it in a liquid in order to asses the identity of the contents or their volume within the sample.

It has also been proposed that fluids may be analysed from the reconstructed gas/fluid emissions formed and identified by the addition of chemicals in a calculated manner. The surface relaxation of fluids has the causal effect of emitting a variable light. The variable light from the chemical reaction helps create the environment where electrons invade the x, y and z axis through a process of spilling. Friedel oscillations are created near the surface of fluids which may or may not screen the ions. Where the ions are allowed to withdraw back into the surface of a material the energy received from the material will be reduced or changed. The changes can be used to indicate the nature of the components of the fluid, this process however suffers from the disadvantage that it relies on a chemical reaction.

The refractive index is used to differentiate the light reflected back from different substances thereby providing an identity, however, the light cannot be clearly identified much beyond 6 decimal places which has the disadvantage of categorising different substances under the same refractive index number.

Mass Spectrometry can also be used for fluid analysis. The objective of the Mass spectrometry is to separate each mass from the next integer mass and this can be achieved in several ways the first of which is via Unit resolution mass 50 distinguishable from mass 51, for example. The magnetic sector using the Gaussian Triangle peak method of differentiation. The Fourier Transform Ion Cyclotron Resonance (FTICR) system utilises twin peaks with a Lorentzian shape and 10% valley resolution. The Time Of Flight (TOF) mass spectrometer is resolved to a 50% peak-height definition incorporating the Gaussian triangle shape. The two peaks are resolved to a 50% valley.

Mass Spectrometry is concerned with the separation of matter according to atomic and molecular mass. It is most often used in the analysis of organic compounds of molecular mass up to as high as 200,000 Daltons, (Atomic Mass Unit) and until recent years was largely restricted to relatively volatile compounds. Continuous development and improvement of instrumentation and techniques have made mass spectrometry the most versatile, sensitive and widely used analytical method available today. However, it would be desirable to have a fluid analyser system capable of a definition of a fluid particle beyond that of a mass spectrometer. Mass Spectrometry also suffers from the difficulty that integrity is problematic. An additional advantage of the present invention is that the samples can be stored.

In Mass Spectrometry radiation sources, such as lasers, are used, the wavelength of current lasers occurs in approximately the visible wavelengths. Conversion of visible wavelengths into shorter wavelength radiation has many practical applications beyond the intrinsic theoretical interest in production mechanisms, as absorption sources, x-ray heating sources, x-ray lasers. Radiation is amplified through laser energy aimed at the sample. The fluid analyser of the present invention does not require additional energy radiation in order to amplify the signal radiative source of the fluid in the sample container to facilitate the identity of the fluid.

U.S. Pat. No. 6,271,522 suggests that spectrometry may be used for gas detection. Similarly U.S. Pat. No. 5,319,199 uses infrared and ultra violet radiation to detect the gases present in vehicle emissions. U.S. Pat. No. 4,746,218 is concerned with spectral absorption to detect and analyse gases. None of those devices enable the simultaneous detection and analysis of a multitude of gases and none of them can detect gases at a low enough concentration to be useful in comprehensive medical diagnosis.

Existing sample collection containers with non-flexible side walls, although sterile and vacuum packed prior to use, suffer from the disadvantage that on breaking the seal in order to capture the desired sample the container is open to receive unknown and potentially unwanted fluids which will contaminate the intended sample and therefore its integrity. The receptacle of the present invention allows for capture of a pure fluid emission/sample maintaining the integrity of the sample. The volume of the air present in any conduit attached to the receptacle is diluted through the fluid emission (flow). Additionally, the receptacle with the captured sample can be placed directly into a fluid analyser system such as that described in co-pending United Kingdom Patent Application 0127913.2 without the need for a method of extraction or decanting.

Existing sample collection bags that are flexible in nature can suffer from the same disadvantages of the collection containers with non-flexible side walls and will generally prevent consistent sample readings if used in such fluid analyser systems as co-pending United Kingdom Patent Application 0127913.2 since the shape of the bag will not be consistent and uniform at specific points. Additionally these forms of bags do not have as high an optical clarity since they are used more for transportation and are not envisaged to participate in the analysis itself.

Existing receptacles used in fluid analyser systems for static or through flow emission sampling are usually made from materials such as glass. With the use of such receptacles, it is not normally economical to dispose of the receptacle(s) after one use and consequently they are re-used. This process suffers the disadvantage of not knowing that the previous sample has been completely evacuated providing an opportunity of contaminating the next/current sample.

There is therefore a need for techniques for fluid analysis that employ a constant, static sample which can if necessary be stored for future use. Furthermore there is a need for analyses that can detect many different components at very low concentrations levels which requires minimal sample contamination. In addition there is a need for such a system where the fluid sample may be taken securely at one location and transported to another location for analysis without risk of contamination. There is a further need to provide disposable sample containers.

In one embodiment the present invention therefore provides a fluid receptacle that may be used for fluid analysis comprising a bag that may be inflated by the fluid, a non-return valve and a fluid delivery tube wherein the walls of the bag are of a material that is flexible, has high optical clarity and whose walls and/or base can receive a temperature measurement probe without penetrating the skin of the bag.

The receptacle of the present invention is particularly useful with a fluid analyser system as described in co-pending United Kingdom Application 0127913.2. Use of the receptacle in such an analyser does not require probes in the fluid to be analysed and enables the analyser to operate on a self contained static fluid sample which thus minimises or avoids contamination of the sample. The use of the receptacle of the present invention has the additional benefit that the sample once taken remains sealed to prevent contamination. In this way the fluid analysers cari be used to develop personal breath profiles which can be stored somewhat like a fingerprint and the stored profile can be checked against a new sample taken at a later date or during health checks.

The analyser systems of co-pending United Kingdom Application 0127913.2 make their analysis by determining the radiation emitted by the sample. Accordingly, when used in such analysis, the walls of the receptacle of the present invention must be of high optical clarity to enable detection of the radiation emitted by the various components in a sample of the fluid so that the radiation may be used to determine the nature of and quantities of materials present in the fluid. When used with such an analyser, the analyser is provided with means for translating the magnified signal into the nature and quantity of the fluids present in the sample said means being referenced according to:
a) the known volume of the inflated receptacle
b) the light condition of the fluid sample
c) the temperature of the fluid sample
d) the duration of the radiation scan and/or
e) the distance of the radiation scan.

The present invention therefore further provides the use in a fluid analyser system comprising:
i) A consistent light condition environment in which the receptacle can be placed.
ii) A timing device for measuring duration of the scan of the radiation emitted by the fluid sample in the receptacle.
iii) A temperature sensor for determining the temperature of the sample.
iv) Detector(s) for receiving data from the radiation emitted by the sample located at a predetermined distance from the sample.
v) Means for translating and magnifying the signal from the detector(s) enabling identification of the intensities and the peak intensity values' wavelengths
   of a receptacle for a fluid sample comprising a bag that may be inflated by the fluid, a non-return valve and a fluid delivery tube wherein the walls of the bag are of a material that is flexible, has high optical clarity and whose walls and/or base can receive a temperature measurement probe without penetrating the skin of the bag.

The degree of optical clarity required will depend upon the use to which the receptacle is to be put. However, when used for fluid analysis high clarity is required as indicated by the transmission of a high percentage of ultra violet and visible light. A solar transmission, as determined by ASTM E-424, greater than 90% preferably greater than 95% is preferred. For this reason fluorocarbon films such as FEP available from Du Pont is a preferred material for the production of receptacles especially those to be used in gas analysis. Use of FEP and like materials has the added benefit that they cannot be compressed.

The walls of the vessel should also be flexible and inelastic. Flexibility means that the material at its thickness of use is able to completely recover its original shape and form from compression, concertina, flat pack, fanfold, stack, bend or twist. This comprehensive flexibility simultaneously maintaining the integrity of the contents within a high optical clarity material. Inelasticity ensures that the receptacle cannot be expanded beyond its desired volume.

In one embodiment rigidity may be imparted to part of the structure through the incorporation of a rigid moulded part such as the top and/or the base of the receptacle. The integrity of the contents is still maintained as aforementioned, however the optical clarity is sacrificed at top and bottom of the receptacle in favour of rigidity and strength.

Optionally the system may also include a light meter for determining the consistent light condition environment.

The peak intensities and peak intensity values of the radiation emitted by the sample in the receptacle may be summed and/or correlated with either known/unknown peak intensities and/or peak intensities values (nm wavelength values) to indicate the nature of the fluids present in the sample and to determine the concentrations of the fluids in the sample.

The radiation detector(s) used is preferably a radiation absorbance device(s) which receives the radiation levels according to the nano metre wave energy received from fluid(s) within the sample of fluid as recorded over a predetermined time span via a divided amalgam-coated glass or other appropriate material surface. The surface records the radiation levels received at the specific nano meter wave divided cells. These cells are convenient indicators used for the purpose of identification of the sample fluid and its intensity volume.

This system may operate via a specially designed, fully coordinated, computer driven software system to provide an advisory status report of the content of the fluid and the conditions under which the test was performed.

The analyser system preferably also includes a means for the measurement of the humidity and dew point of the sample in the receptacle and also means for determining the atmospheric pressure. These measurements can be stored to enable these factors to be taken into account if and when the profile is compared with another sample or for reference purposes. This may be the case when the analyser is used for fluid/emission analysis for health and environmental purposes. In a further preferred embodiment the system is provided with a GPS so that the date, time and location (altitude, longitude and latitude) of the position where the sample was taken can be recorded.

The system preferably also includes a means for the measurement of gravity, sound and vibration, velocity and direction.

The use of the receptacle of the present invention enables the detection of the presence of a multitude of fluids in a sample and they can also detect the presence of the amounts of fluids present as low as parts per billion and lower. The use of the receptacle of the present invention has the benefit that it may be used at anytime by trained operators in most environments and conditions. Furthermore, the analyser system is versatile. For example, the sample may be taken in the receptacle at one location and the scanning and analysis system may be used in the same or another location. The detection signal, either via a remote control or operator, may then be transferred to another location for magnification, analysis and/or storage or kept in the same location for magnification, analysis and/or storage. Data may also be received in the same manner and this data and any other stored data may be used for comparative purposes being checked against any previous or current internal and/or external test results. If the data analysis system is at a different location from the sample taken, it is preferable to install relevant reference data into the fluid analyser system including the time, conditions and location of where the sample was taken, thus maintaining the integrity of the reference data.

The techniques of the present invention may be used to collect samples in an industrial environment for the detection of gases in particular pollutants and toxic gases in for example mines, chemical plant, oil rigs, oil wells and the like. It may also be used in the evaluation of engine combustion, the emissions generated and their interaction with the environment. It is particularly useful in the detection of particulates. This is useful in the monitoring of engine performance, which is becoming increasingly important as environmental legislation becomes more severe. This is particularly relevant to diesel engine performance. The techniques may also be used to collect sample for analysis to aid environmental studies where atmospheric changes are significant such as in weather forecasting and forecasting, volcanic eruption and earthquakes. Additionally, samples may be obtained to detect different gases or combinations of gases that plant life can produce prior to earthquakes.

A particular use of the techniques of the present invention is in the detection of the content of human and animal breath. The techniques therefore may be used to collect samples to enable the production of data for the monitoring of human health. In addition, the ability to take and scan samples in one location, such as in the home, in an ambulance or at an accident site and transmit the results to, for example, a doctor's surgery or a hospital for analysis and the production of results can enable more rapid diagnosis and treatment.

When used for fluid analysis in order to get a sharp image of the radiation emitted by the sample in the receptacle the walls of the receptacle should have a high optical clarity. The side walls of the receptacle should be flexible but not elastic. The receptacle is preferably provided with a one-way valve to enable it to be filled through the one-way valve. The valve will prevent escape of the introduced fluid and ensures that the receptacle is automatically closed when it is full. The receptacle should be such that there is minimum contamination and may be supplied flat packed and vacuum packed and, according to the use, may be sterilised prior to packing. The size and the shape of the receptacle are not important and will depend upon the environment in which the analyser is used.

The materials used to make the receptacle should have minimal absorption and dispersion rates and withstand potentially very high temperatures. The walls of the receptacle are preferably thin to improve the optical clarity and the accuracy of the fluid sample temperature measurement.

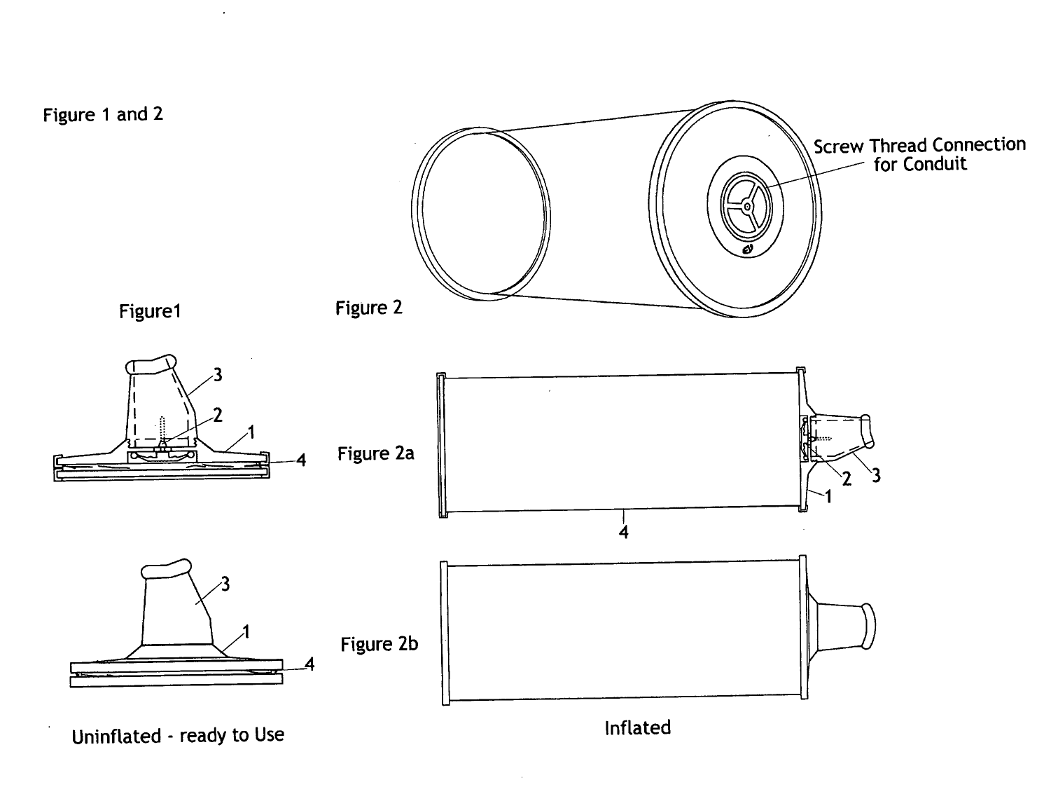

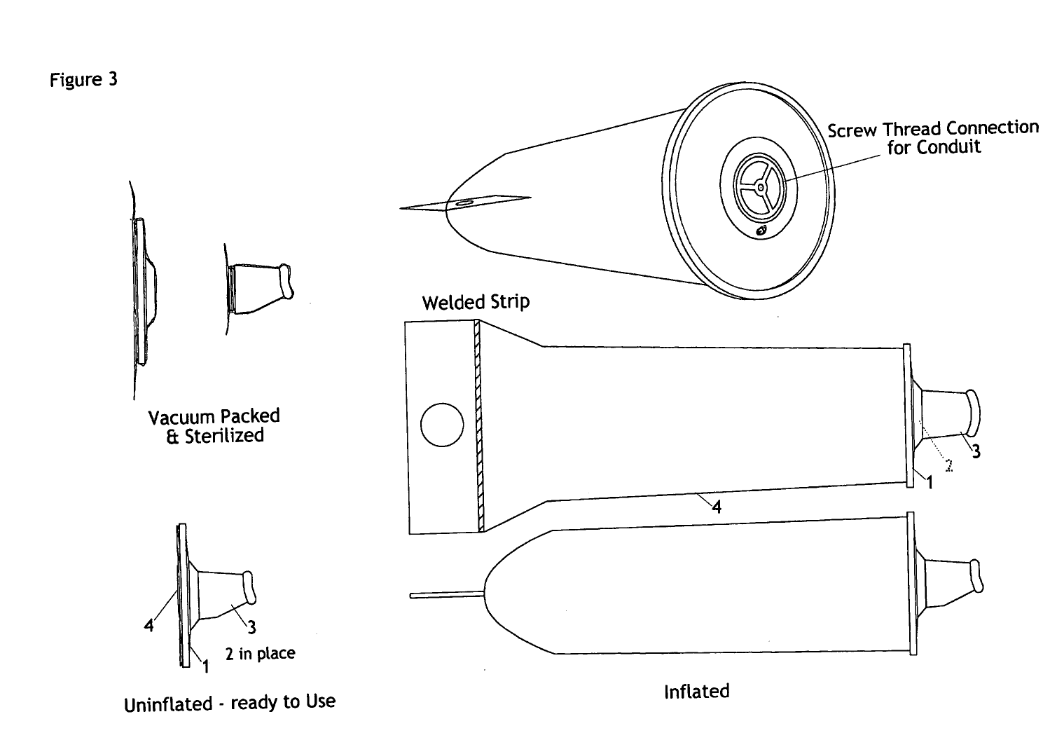

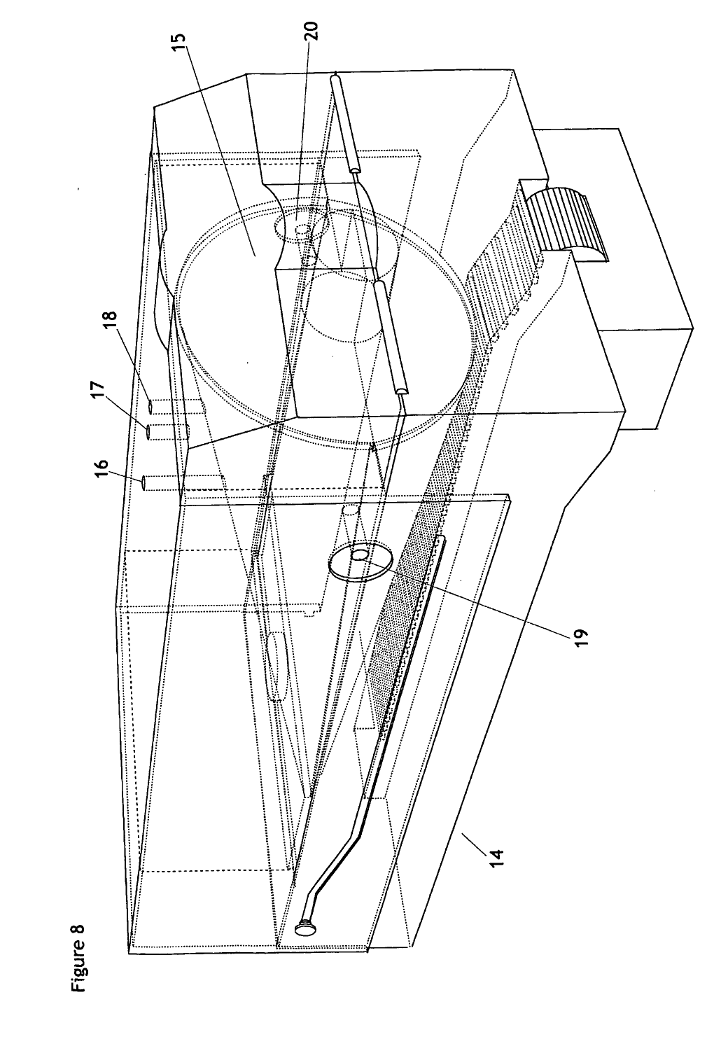

The receptacle is conveniently made by mass produced methods and we have found that fluorocarbon (polytetrafluorethylene), such as FEP, preferably virgin FEP, supplied by Du Pont, MFA Ausimont and PFA are particularly useful materials from which the sample bag can be made. Conveniently the receptacle is made in five pieces, the sample bag itself, the non-return valve, the non-return valve holder, tamperproof clip and a fluid delivery tube such as a mouthpiece. For the receptacle which provides a firm fit for the consistent light environment chamber in FIG. 8, the bag is preferably extruded and sealed at one end by a welding technique (see FIG. 3). The bag is provided with an opening into which the valve holder and valve can be sealed and clipped. The valve holder may be injection moulded as can the valve and fluid delivery tube from materials such as medical grade polypropylene, as can the base for such receptacles as shown in FIGS. 1 and 2. A vacuum is created within the receptacle, the receptacle is then sterilised and vacuum packed to avoid contamination prior to use. The valve can be made from any suitable material, it should be flexible and recover rapidly. Elastomers may be suitable. The tamperproof clip is typically a tension ring which should be strong and flexible pulling back towards its original shape. It may be made from synthetic rubber.

We prefer that the side walls or bag of the receptacle are extruded and seamless, we also prefer that they have a thickness of from 25 μm to 150 μm, 30 μm to 100 μm, more preferably 40 μm to 75 μm most preferably of approximately 50 μm. These wall thicknesses ensure the collapsible, resurrection and flexible nature of the receptacle. We have also found that at this thickness the walls are strong enough, are non-elastic on inflation and provide high optical clarity. The material properties at this thickness also provide a firm or moulded fit around or inside objects. The diameter of the extruded material which forms the side walls or bag of the receptacle is preferably less than the diameter of the valve holder. If the extruded material were thinner, it is arguable that the optical clarity would increase. However, the walls of the receptacle would be weaker and more likely to tear and the rate of heterogeneous catalysis vectoring involving physisorption, which is the process of absorption (chemisorption) between two substances, would increase. If the extruded FEP was thicker, more material would be required, the material property's benefits would diminish such as the walls would not be as optically dear.

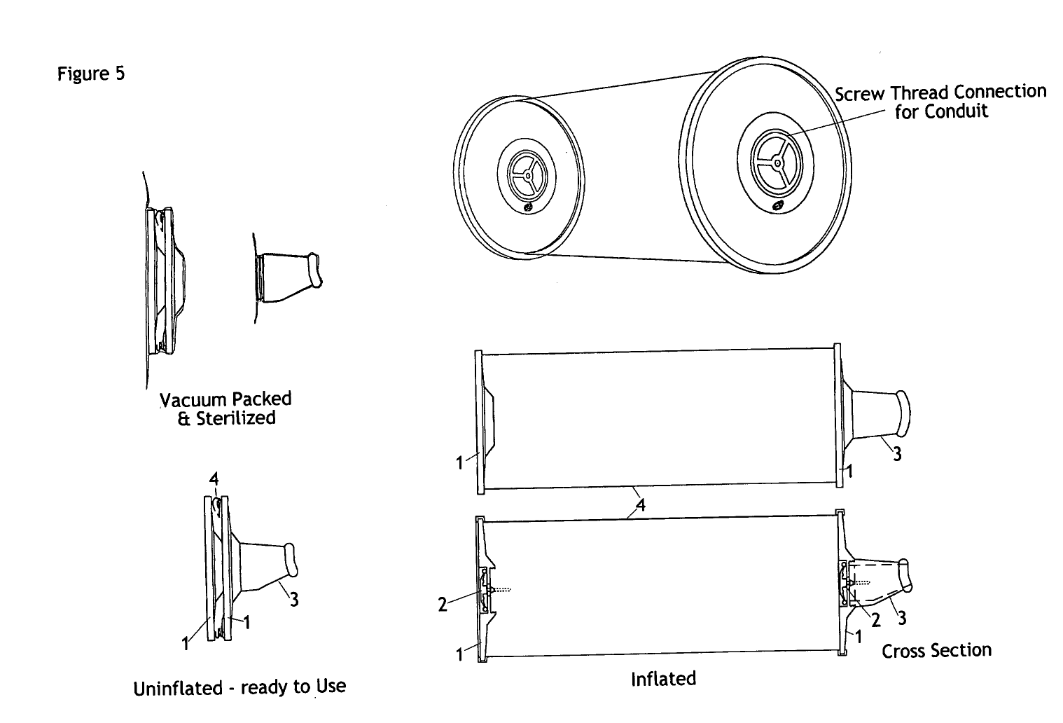

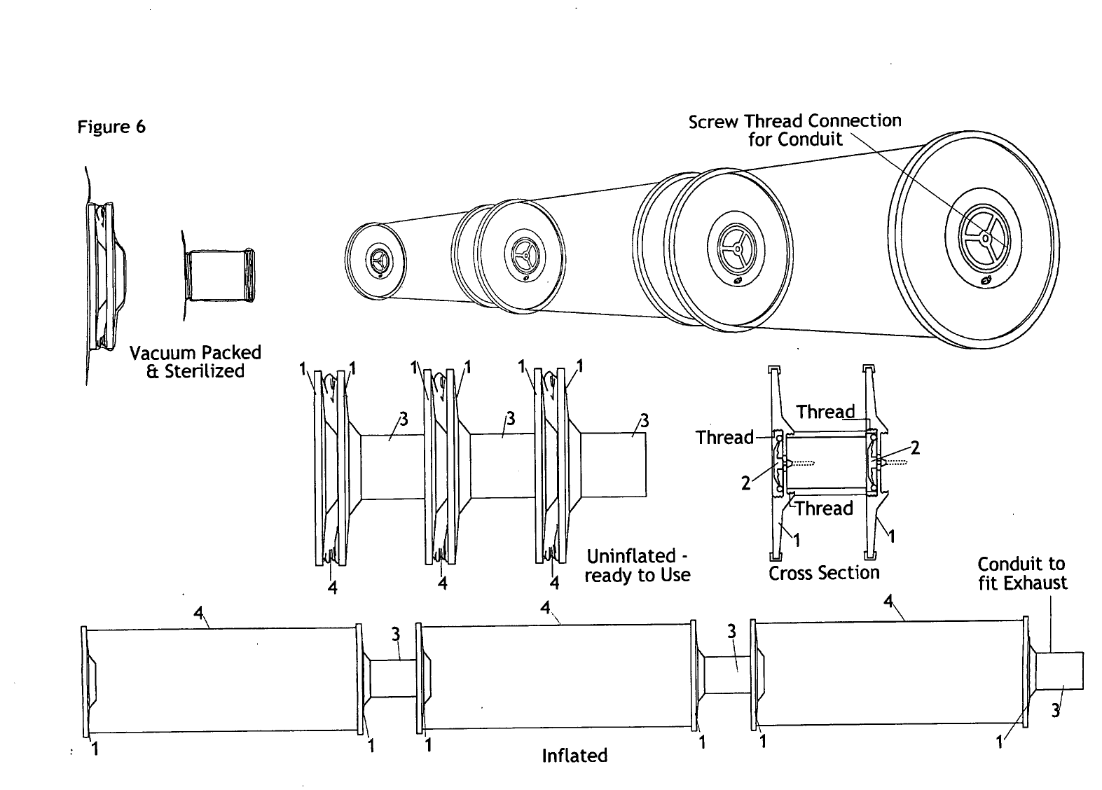

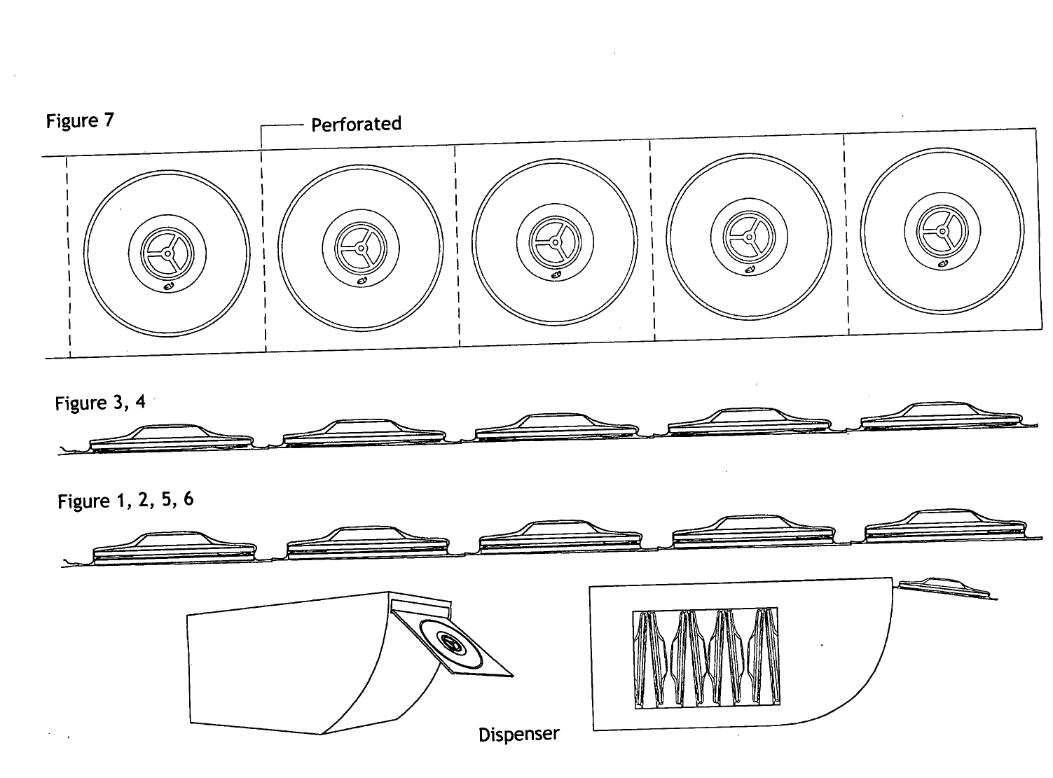

The valve holder is preferably non-flexible and when assembling the receptacle, the valve is inserted into the valve holder which, in turn, is inserted into the extruded material allowing the non-elastic nature of the material to mould around the shape of the valve holder providing an air tight seal which may be secured by a clip. To prevent the receptacle being tampered with, to allow increased pressures into the receptacle and to hide the extruded end, a tamperproof clip, which may be a circular band, may be applied surrounding the edge of the valve holder. The size of the tamperproof clip is preferably less than the diameter of the valve holder providing tension when in place. The base of the receptacle is preferably either welded or folded and welded to provide a receptacle as shown in FIG. 3. Alternatively to make the receptacle in FIGS. 5 and 6, the base is assembled in the same manner as the top (valve, valve holder and tamper proof clip). The receptacle in FIGS. 1 and 2 is assembled in the same manner as FIGS. 5 and 6 except the base is a flat non-flexible disc with tamperproof clip.

We prefer the valve-holder to be rigid because the tamperproof clip, when used, can apply pressure around the top of the receptacle when attached and it is desirable that the top does not flex under the tension. Additionally, the use of a rigid valve-holder allows the shape of the side walls to remain uniformally cylindrical at certain points. It also allows the receptacle when pulled from the base in its collapsed state to receive the fluid emission and maintain a consistent volume. The valve holder is preferably shaped so that a fluid delivery tube, such as a mouthpiece can be readily attached to the top of the receptacle.

It is preferred that no resins or adhesives are used in the assembly or manufacture of the receptacle ensuring that the integrity of the contents of the receptacle is maintained. A vacuum is created within the receptacle, then sterilised and vacuum packed to avoid contamination prior to use. Two or more receptacles may be linked in series to allow parallel analysis of more than one sample. The lack of adhesives and resins also makes provision for the ability to disassemble the receptacle into the individual components and materials that made the receptacle. Therefore the components can be recycled cleanly or cleaned and reassembled. Although for fluid analysis it is preferable to use the receptacle only once.

When used in an analyser system employing a consistent light environment the shape of the inflated receptacle should be such that it is a firm fit within the consistent light condition environment of the fluid analyser system. We prefer that in this embodiment the receptacle, upon inflation by the fluid to be analysed is cylindrical at the point where the radiation detectors are positioned. The valve and the materials from which the container is made should be such that the container cannot be expanded beyond its original capacity due to inflation by the pressure of the sample.

At the time of collection of the sample of the fluid to be analysed it is preferable that the temperature of the sample should be measured and recorded together with other significant information such as the humidity, atmospheric pressure and location.

At the time when the fluid sample in the receptacle is to be analysed by the fluid analyser, it is also preferable to determine the temperature of the fluid sample. A mechanism is preferably provided for a temperature probe to be inserted through a wall of the consistent light environment chamber to touch the skin of the sample bag contained within the consistent light environment. The probe without penetrating the skin makes contact with the sample bag. Due to the flexible nature of the sample bag, the wall of the bag can surround the temperature probe encasing the tip and the fluid analyser system can then start taking measurements and the material from which the receptacle is made should be such that it enables this to happen. Alternatively, a small cavity may be provided in the receptacle to enable receipt of a temperature probe. The mechanism driving the temperature probe is controlled by variable resistance ensuring for each time the probe is positioned it will be encased by the bag but penetration is prevented. Measurements of the ambient temperature of the consistent light environment chamber can also be taken and recorded.

When used in the preferred analyser system the duration of the scan of the material in the receptacle is pre-determined. The measurement of duration is the receiving device(s)'s allowable exposure time to the radiation source (fluid sample). From start to finish the time increment can vary according to the user's requirements typically ranging from but not limited to milliseconds up to 7 seconds and beyond. As previously mentioned it is preferred to use Charge Coupled Device (CCD) detectors to register the radiation emitted by the sample.

Further arrangements may also be made for the determination of the humidity and thereby the dew point of the sample in the receptacle. It is however important that the sensors do not penetrate the skin of the container so that there is no physical interference with the fluid sample.

In the preferred operation once inflated with the sample of the fluid to be analysed the receptacle is placed into the consistent light condition, preferably dark environment compartment next to detector which is preferably a Radiation Absorbance Device(s) (RAD). The compartment should then be closed so that normal light will not interfere with the analysis of the fluids. The light reading in the compartment can then be measured and recorded. The process variables such as temperature, pressure and humidity are then measured and recorded. The Radiation Absorbance Device(s) (RAD) then take a measurement of the various radiations emitted by the sample over a pre-determined period of time. To determine the presence and quantity of pre-selected individual fluids, the analyser system having magnified the data of the scan, matches and analyses the wavelengths specifically concerned and their peak intensities against known data already stored in the fluid data base. Alternatively, the preferred method of detecting fluids that are unknown at the time of sampling is to utilise the full range of the Radiation Absorbance Device(s) (RAD), whether sub-infra sonics, infra sonics, sonics, ultra sonics, microwaves, infra red, ultra violet, x-ray, gamma, cosmic and ultra-cosmic. In the preferred operation the process variables such as temperature, pressure and humidity are then measured and recorded again. The fluid analyser system software can then not only determine the fluids present in the sample through a databank of the known wavelengths of fluids, but can also compute the amounts of each identified fluid present through the measurement of the fluid intensities.

The data that is collected by the analyser is preferably magnified using standard curve fitting and signal magnification techniques which can incorporate multiplication and spectral splitting of the pixels. The magnified signal may then be used to identify the fluids present in the sample via the software. This is achieved by comparison against a stored information bank of known wavelengths of fluids. Each molecule of a differing nature will have differing levels of resonance or wavelengths. The system preferably uses software that can sum the absorbances at each of the particular values during or after the radiation measurement, to give the quantity present of each of the fluids which have been identified, within the spectral range (nm) of the Charge-Coupled Device (CCD) detectors being used within the RADs. Knowing the volume of the inflated receptacle used, the fluids are expressed as a percentage of the sample(s). The accuracy of the measurement may be increased by taking multiple measurements of one or more samples.

All fluids at the time of sampling will be analysed under the same conditions. Even though each sample's process variables such as temperature or pressure may differ. The intensity values recorded will be in proportion at the time. The individual values of intensity are not as important as the relationship they have as a portion of the whole. Therefore, if temperature changed, the registered intensity values throughout the spectra analysed will change accordingly at the time. Consequently, the volumes identified will be in accordance to the process variables at the time and location of sampling. The temperature variance is important as changes to the registered and non-registered intensity values are not linear when expansion and retraction occur.

Having been able to identify the fluids present with their volumes expressed as a percentage of the sample, many characteristics of the fluids, such as weights and sizes can be determined. This will help construct a far more comprehensive picture and moving model of fluids and their real time activities.

The invention is illustrated by the accompanying drawings in which

FIG. 1 shows a cylindrical shaped receptacle of the present invention in uninflated form.

FIG. 2 shows the cylindrical shaped receptacle of FIG. 1 in inflated form.

FIG. 3 shows a receptacle of the present invention to be used for collection of the sample to be analysed by the consistent light environment chamber in FIG. 8.

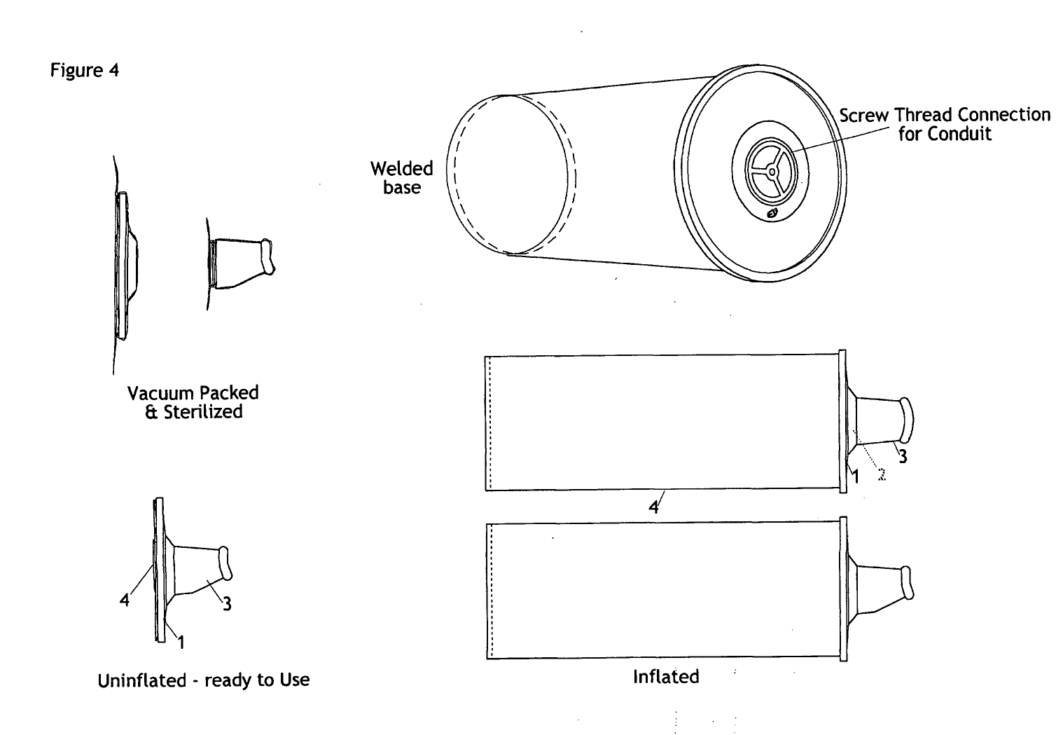

FIG. 4 shows a receptacle of the present invention with a flexible base which can be used, on inflation, in an appropriately shaped consistent light environment chamber for analysis of a fluid sample.

FIG. 5 shows a receptacle of the present invention which can collect a fluid sample. The valve holders and valves are positioned at either end of the extruded bag enabling the fluid emission to pass through the now inflated receptacle and at any given point in time, a sample can be collected of the fluid emission.

FIG. 6 illustrates how several receptacles of the present invention such as those illustrated in FIG. 5 may be used in series to enable parallel analysis of more than one example. By different arrangement, the connected receptacles maybe positioned differently and contained within one form.

FIG. 7 illustrates how receptacles described in FIGS. 2 to 6 can be distributed and dispensed individually by tearing/breaking the perforation. The conduit of any description may then be attached.

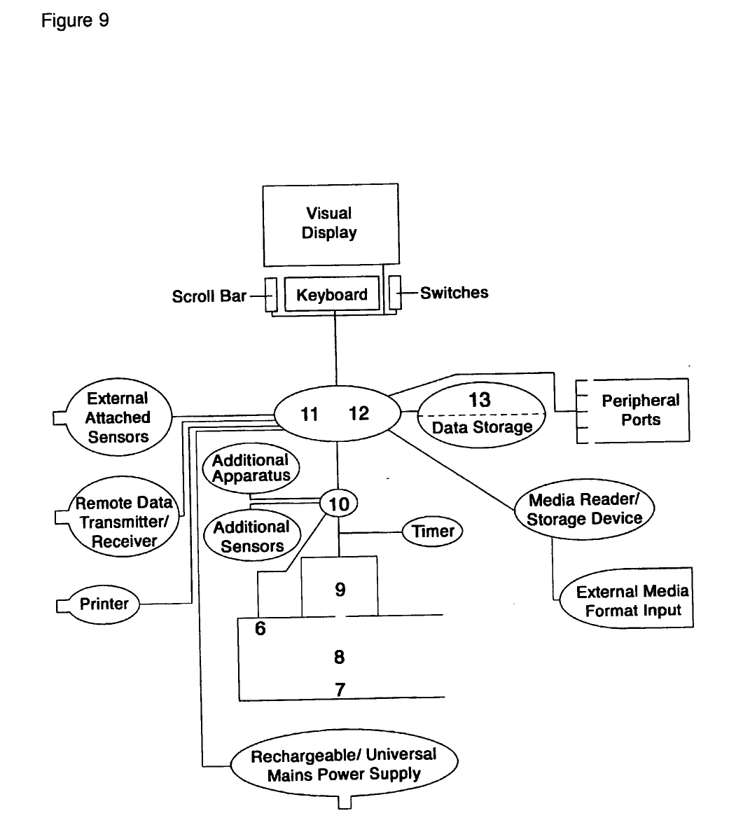

FIG. 8 is a cut away view of the consistent light environment compartment of an analyser which may be used to analyse a fluid in a receptacle placed inside the analyser and shows a housing (14) in which is a compartment (15) for receipt of a receptacle according to the present invention containing the sample to be analysed. The compartment may be removable and replaceable to accommodate different receptacle shapes and sizes such as those illustrated in FIGS. 2, 4 and 5. A light sensor (16), an ambient environment temperature measurement (17) and a sensor (18) for measuring the sample temperature are provided. In addition the wall of the compartment is provided with detectors (19) and (20) which, in a preferred embodiment, are multiple CCD fittings. The compartment as shown in FIG. 8 may then be connected to a recorder device such as that illustrated in FIG. 9.

FIG. 9 is a diagrammatic illustration of how a receptacle of the present invention can be used in gas analysis.

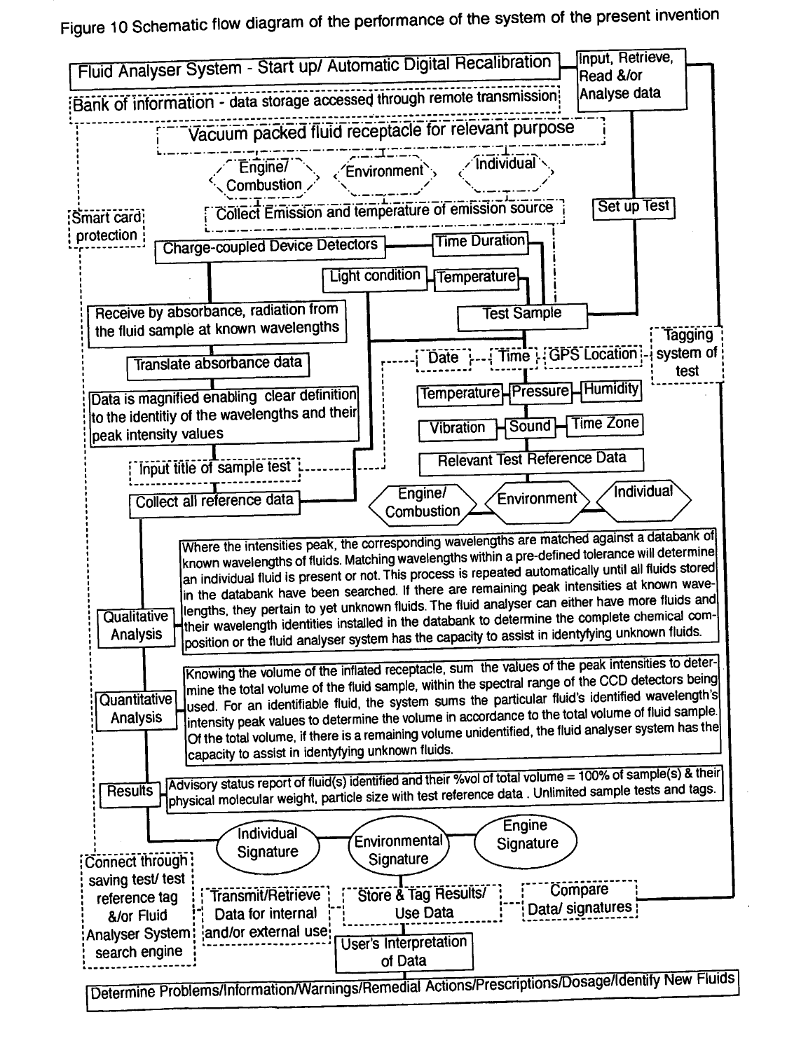

FIG. 10 is a schematic flow diagram of the performance of an analytical system using the present invention.

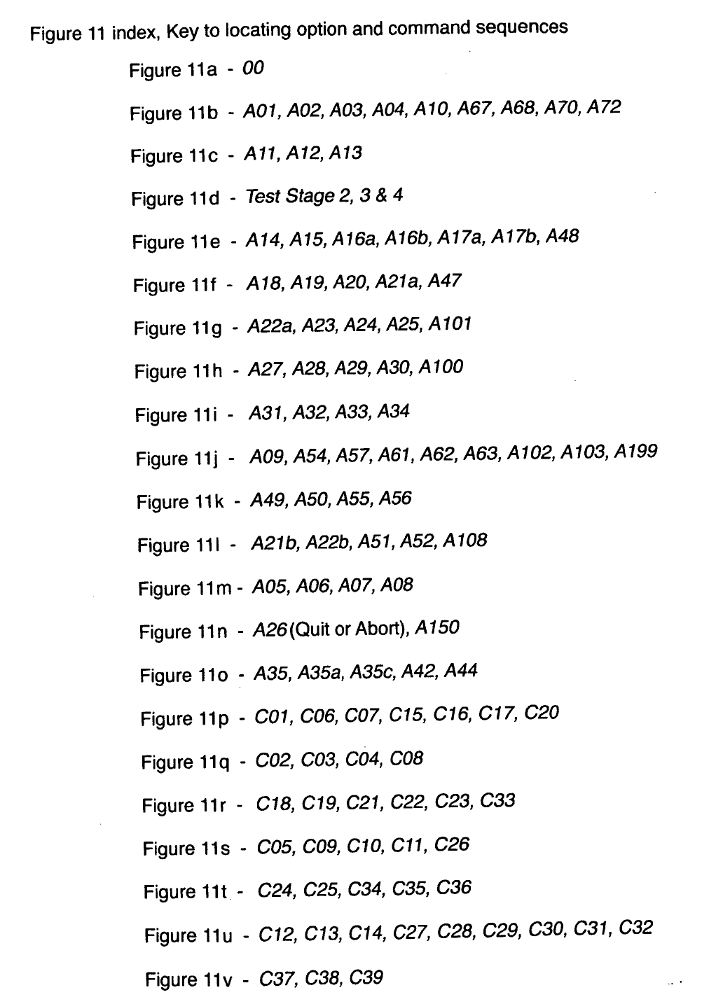

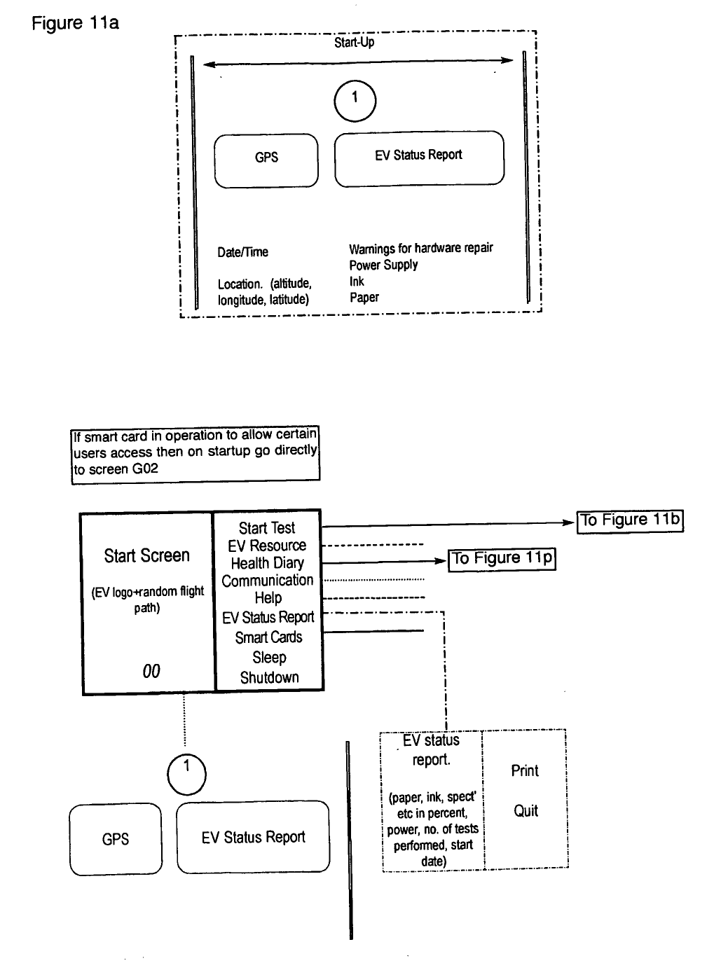

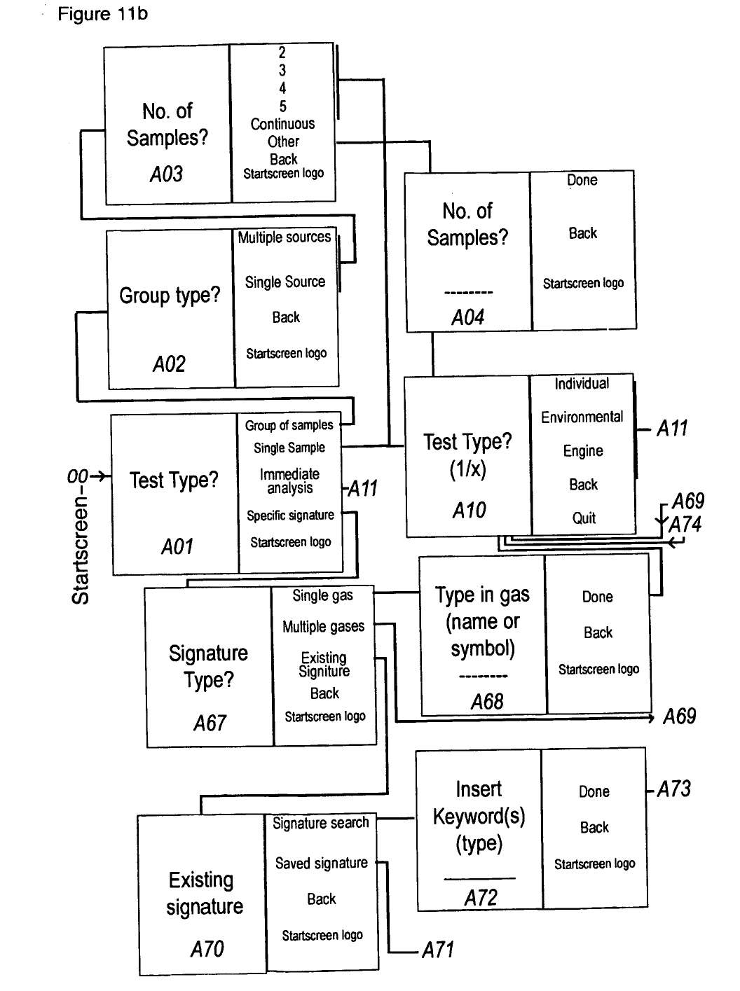

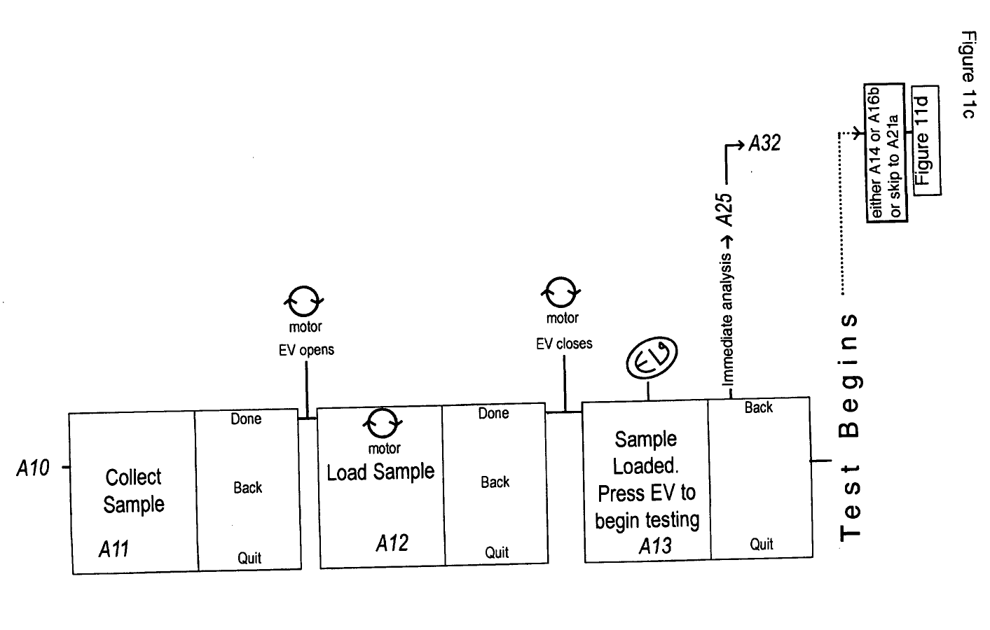

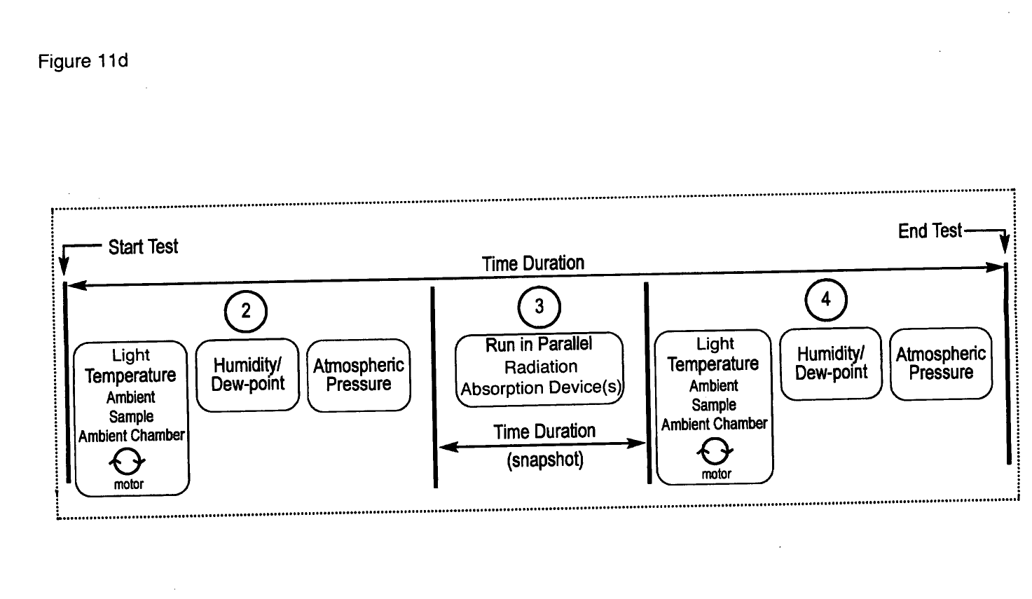

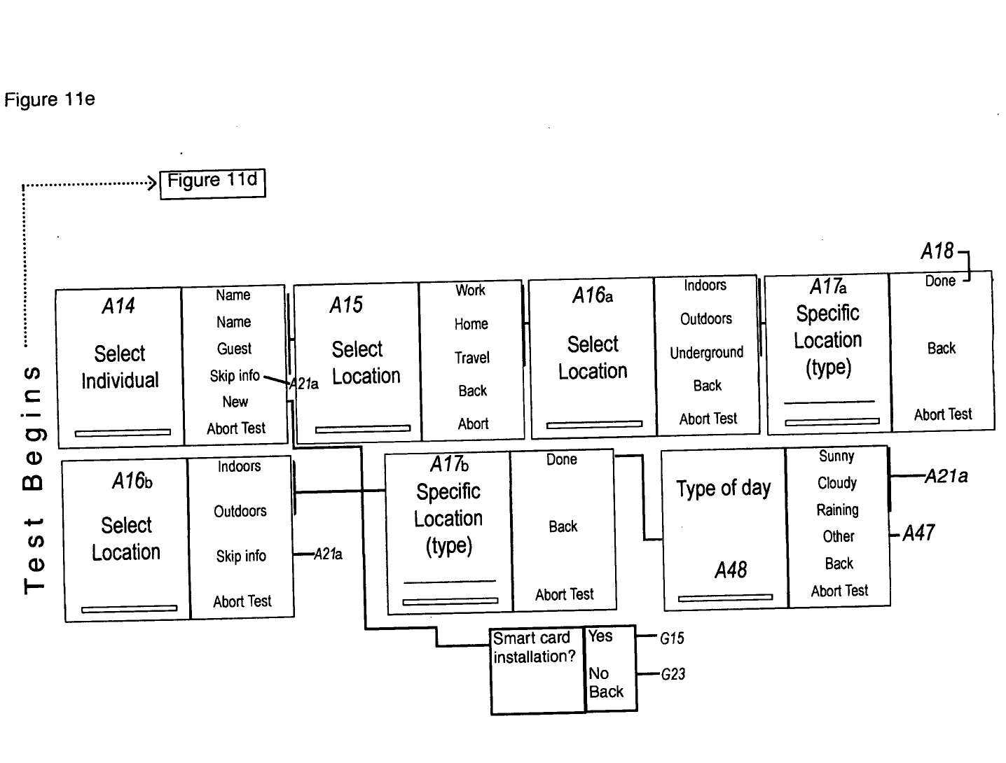

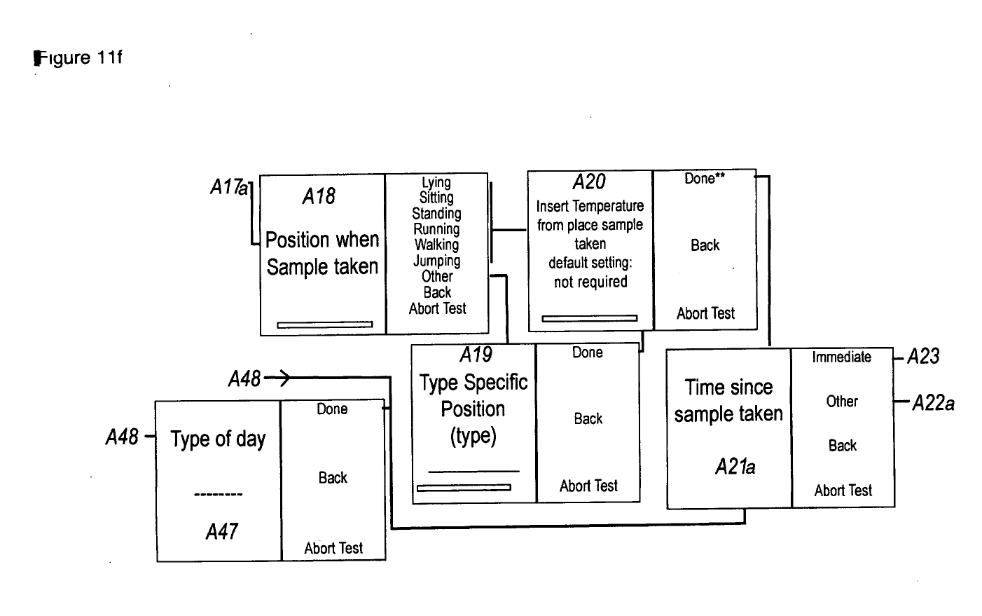

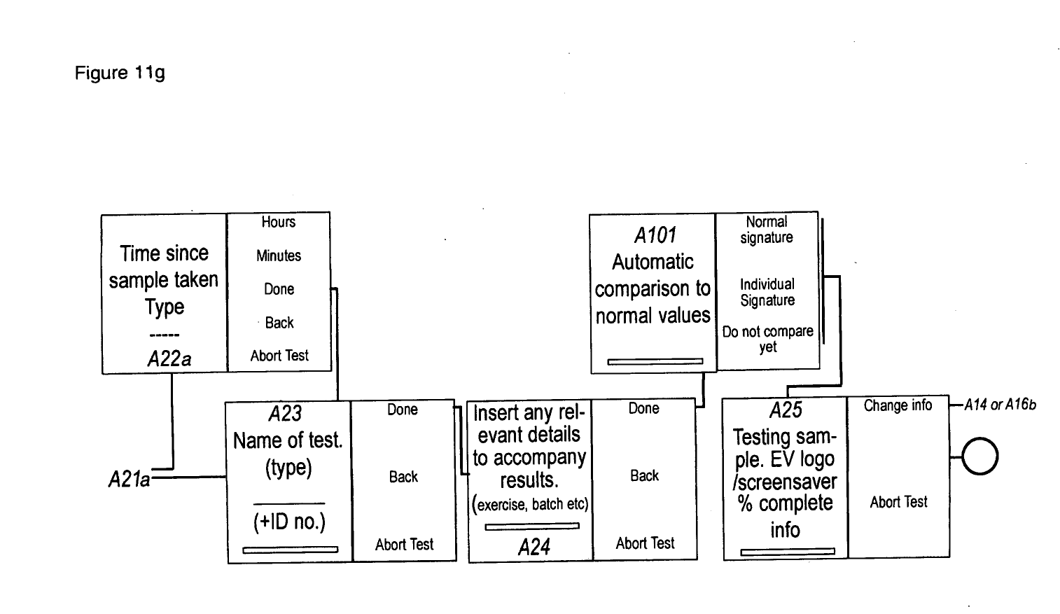

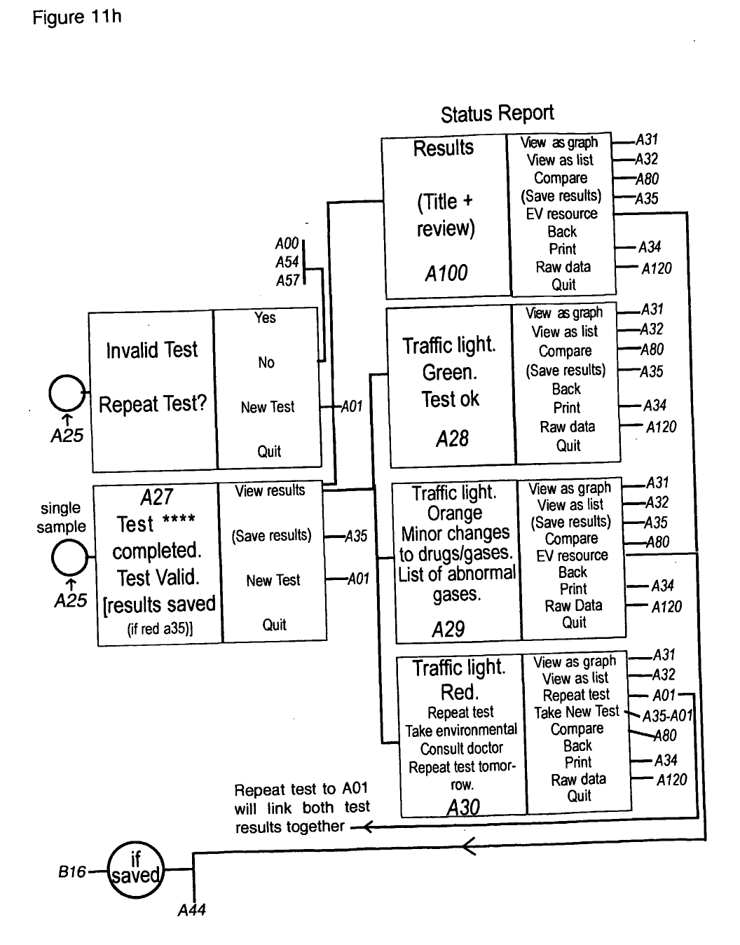

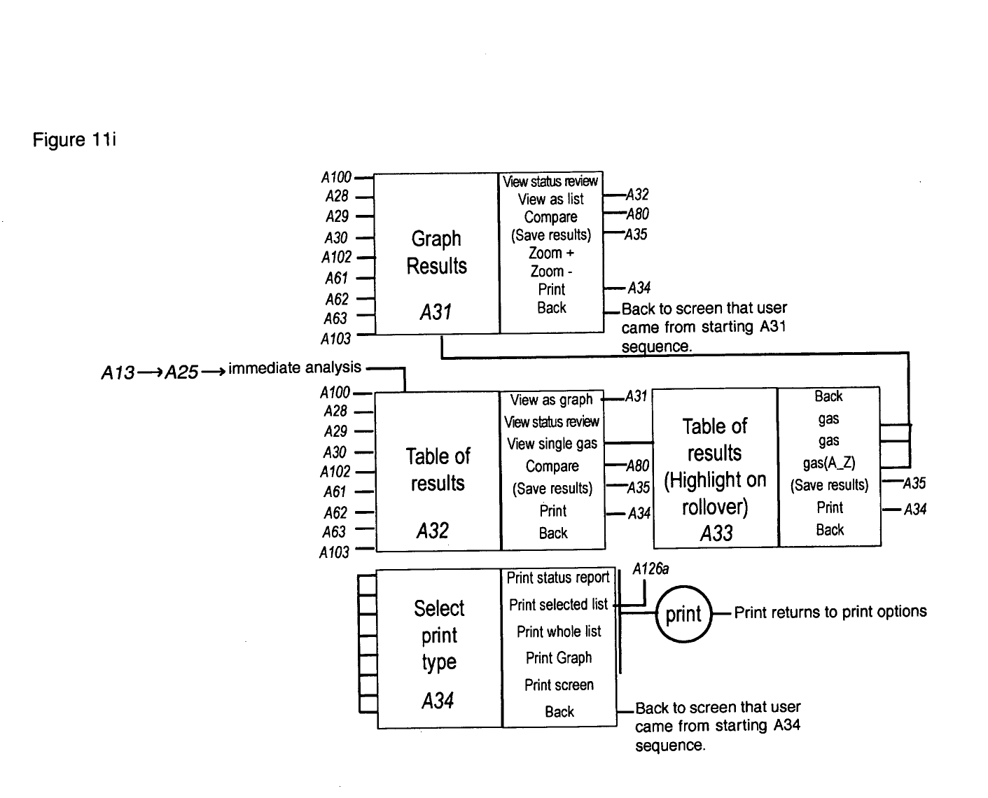

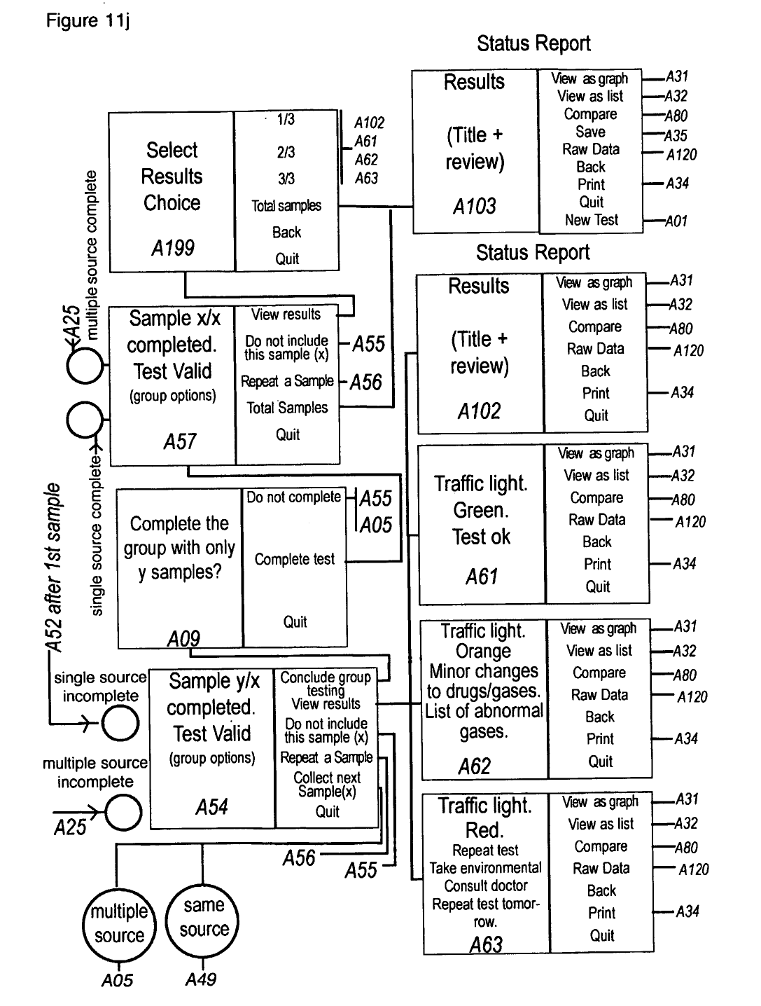

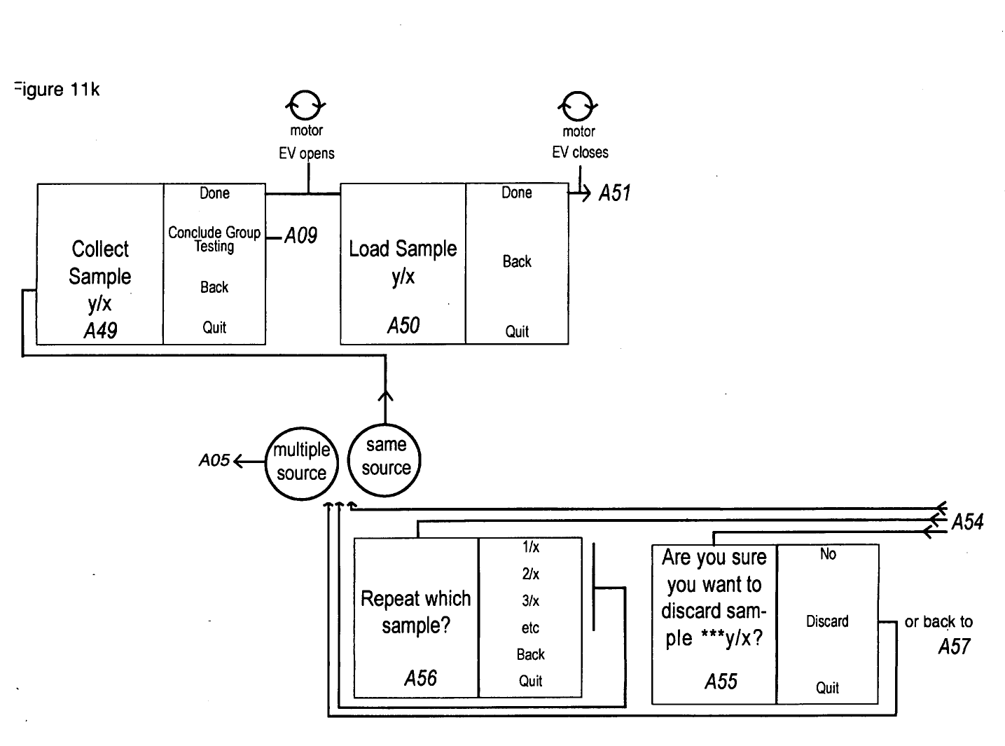

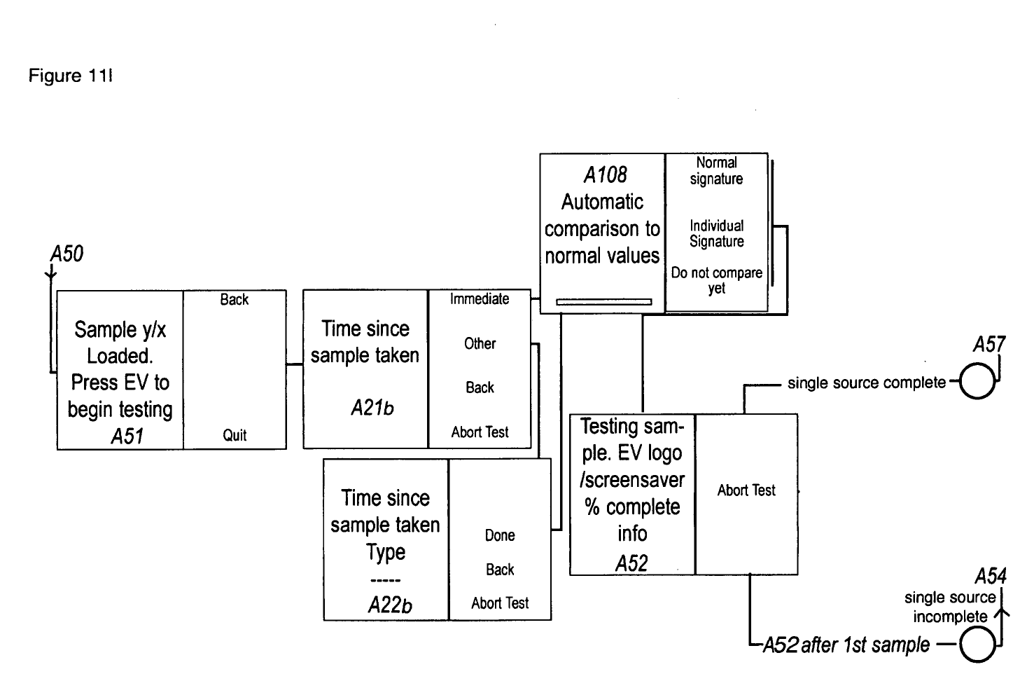

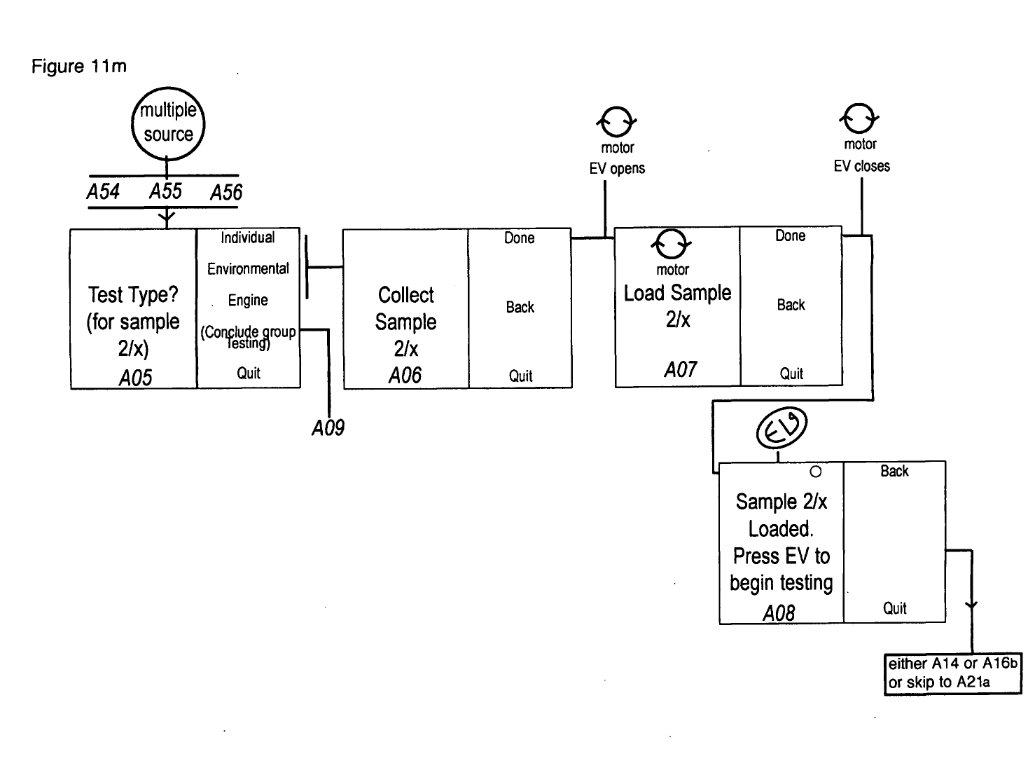

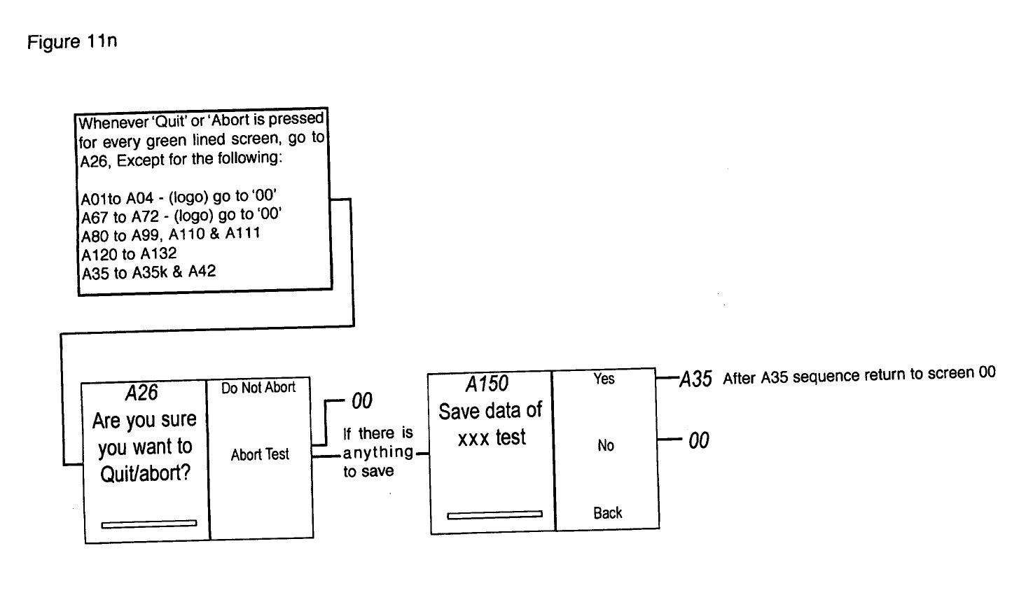

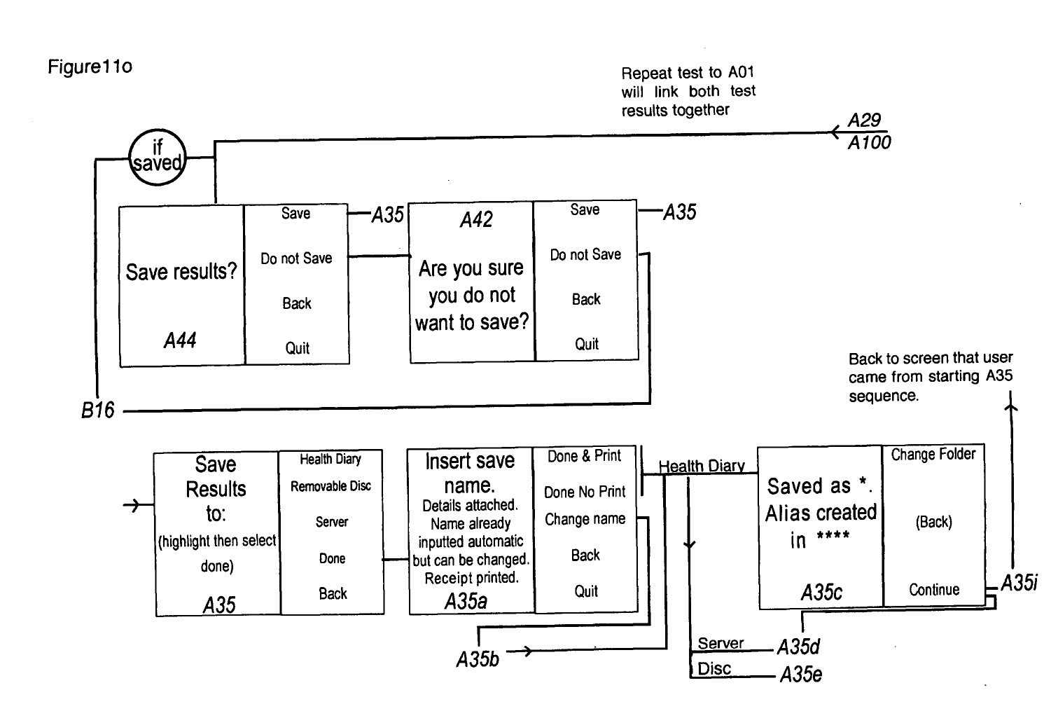

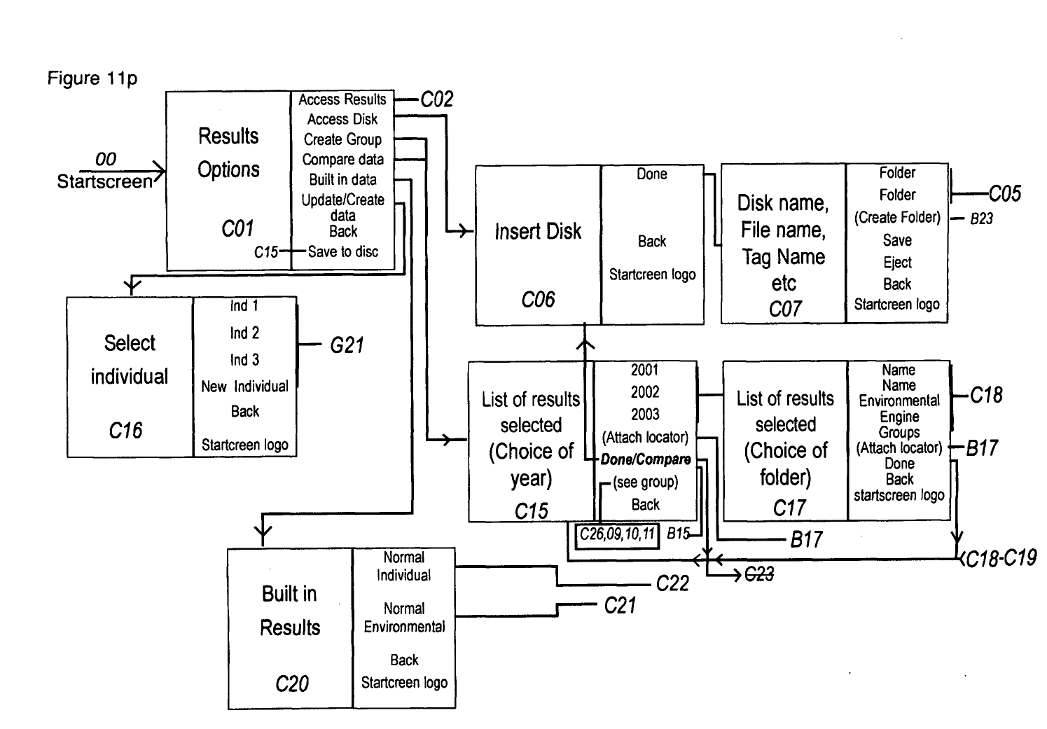

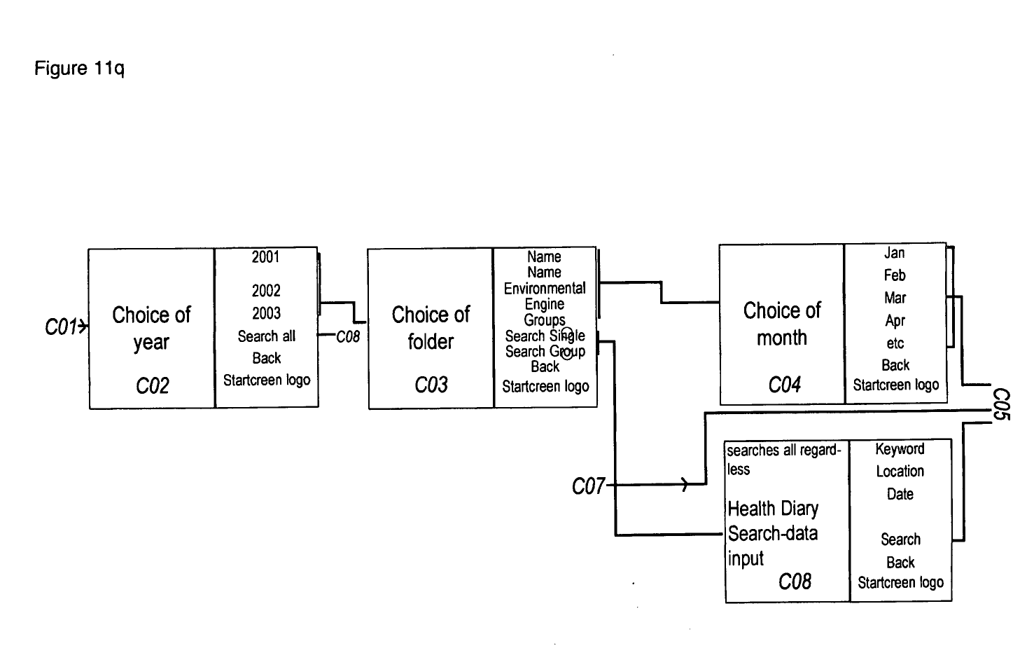

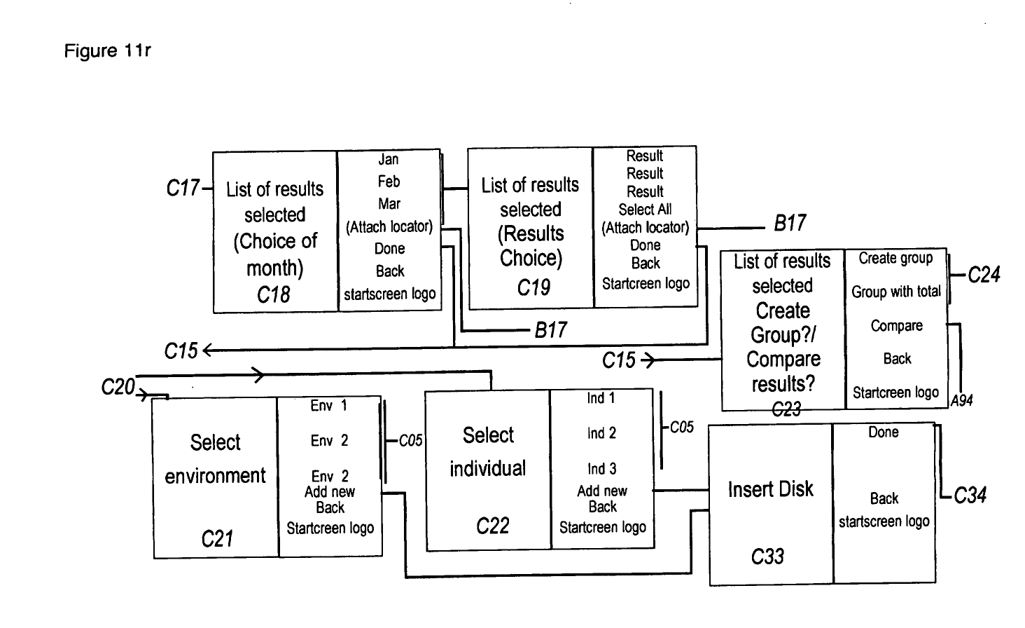

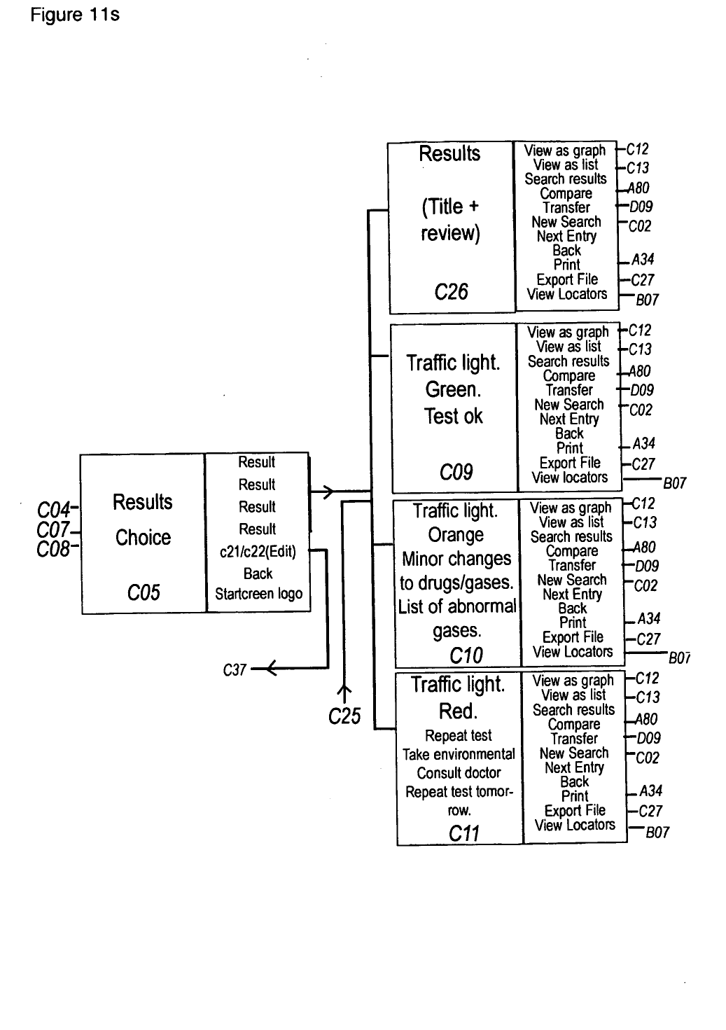

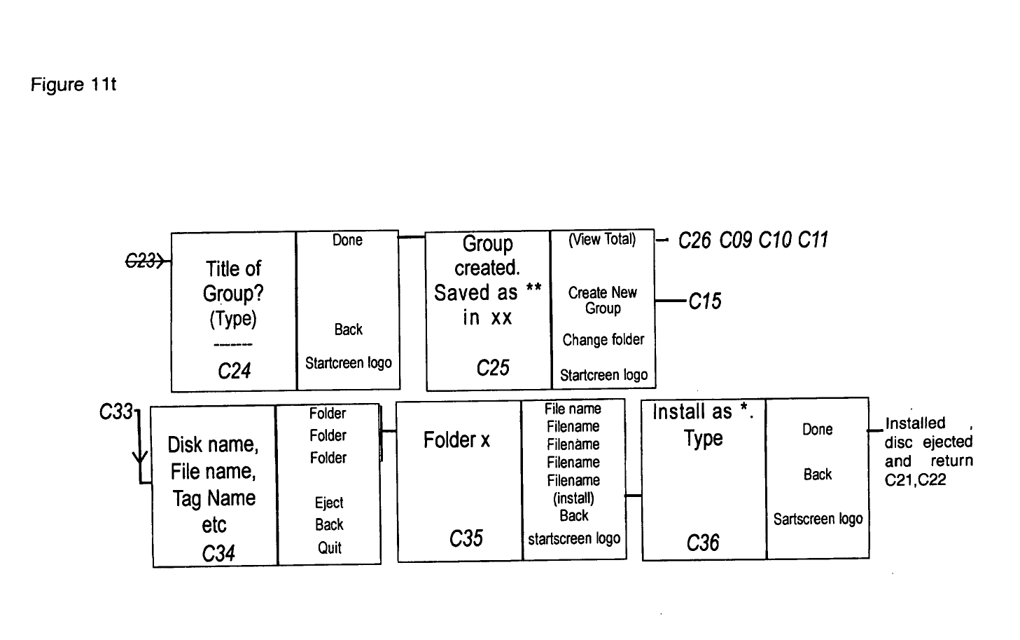

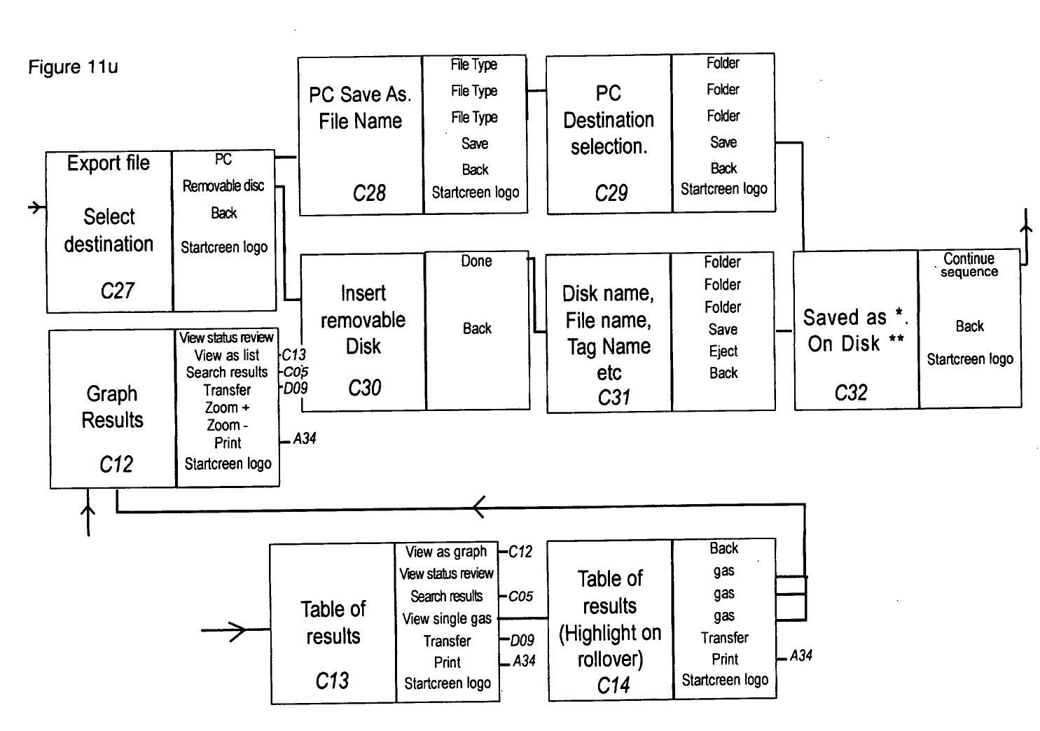

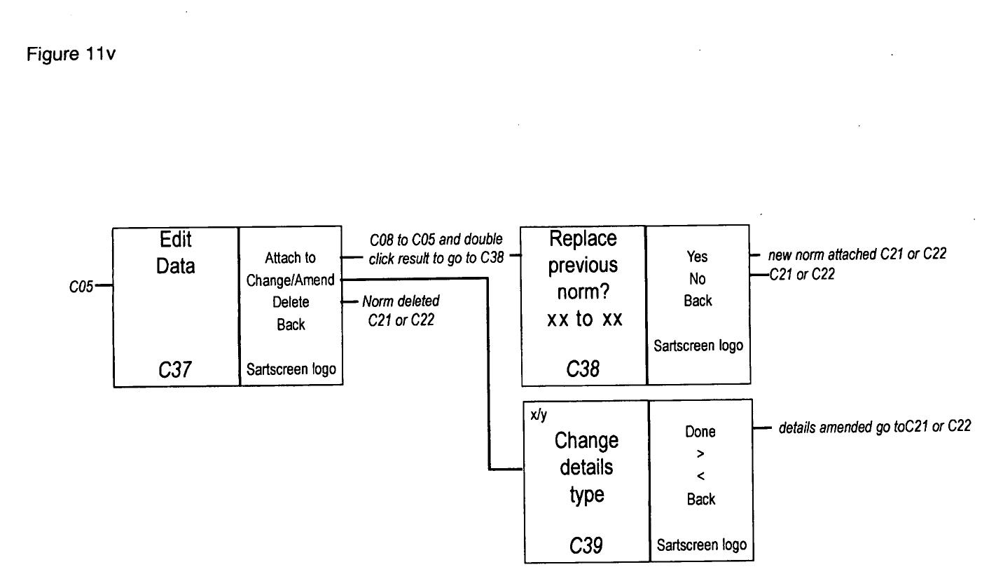

FIG. 11 illustrates how the present invention can used to compile a health diary.

A preferred form of a receptacle of the present invention for use in the collection of samples is shown in FIG. 1 which is a cross section of the receptacle in uninflated packed form. The receptacle which is preferably sterilised and vacuum packed to avoid contamination consists of a top (1) on which is mounted a non-return valve (2) and a conduit (3) through which the fluid sample may be supplied. The flexible sample bag (4) is collapsed which is sealed/attached at the base and the top.

FIG. 2a is the side elevation and shows the receptacle inflated with the fluid sample. FIG. 2b is the front elevation, which also shows the receptacle inflated with the fluid sample.

In use the vacuum packed seal(s) of the receptacle is broken, the sample collected through the conduit (3 of FIG. 1) from the pressure of the flow of for example exhalation and/or emission; or alternatively through the conduit (3 of FIG. 1) so that a sample from the environment is collected. This is achieved by pulling the base away from the top (1) releasing valve (2) until the receptacle, FIG. 1, is fully inflated, as shown in FIG. 2. The valve automatically returns to its closed position once the receptacle is fully inflated or the motion of pulling the base away from the top stops. To use the receptacles in FIGS. 3, 4 and 5 the same methodology can be applied.

The receptacle is a non-pressurised sample collection method due to the fact there is no additional power or assistance required other than that of the flow of the fluid being collected and/or pulling motion. This helps to maintain the integrity of the sample. The receptacle once full, as shown in FIG. 2, is sealed with valve (2) and therefore is unable to pollute the fluid analyser system. The receptacle is preferably used only once to maintain the integrity of the collected sample, it can then be disposed of carefully or the individual components making the receptacle can be disconnected for recycling.

If, as in one example, the collected sample is to be stored for long periods of time prior to analysis a screw cap of some description which may be fluorinated may be used to further prevent contamination of the sample. The thread of the valve holder may be used to attach the screw cap

FIG. 9 is a diagrammatic illustration of the apparatus of the present invention. The apparatus consists of a consistent light environment chamber (6) into which the inflated receptacle of FIGS. 2 to 5 can be fully inserted. The apparatus is provided with a lid (not shown) so that when closed the consistent light environment chamber and the inflated receptade remain in a controlled light environment. The apparatus is provided with sensors (7) which determine the temperature in the consistent light environment chamber, the temperature of the fluid sample and the level of light.

The analysis process can be activated through the interface controller (10) which, simultaneously activates a timer. Once the radiation absorption device(s) (9) are activated, they start recording the radiation from the sample (8) and the timer records the duration of the measurement which stops once the pre-determined duration time has elapsed. The measurement concerning the intensity levels detected by the RAD(s) at known wavelengths is transferred to a computer system (11) and (12) where the signal is translated and magnified. The peak intensity wavelengths are then identified and transmitted to be referenced against a database (13) of known data of wavelengths of fluids to determine the identity of fluids present. The computer (11) also provides means for calculating the total and individual volumes of fluids present referenced against the known volume of the receptacle and the process variables.

Preferably, the analyser consists of the rest of the apparatus or combinations thereof shown in FIG. 9.

In addition the fluid analyser system has the ability to be linked to multiple fluid analyser systems or peripheral devices for the purpose of transferring, comparing, referencing and/or using data. Multiple fluid analyser systems may be present in one form. For example, there may be any number of light consistent environment chambers (6), sensors (7), RADs (9), configured in the same arrangement as FIG. 9 linked into the computer system (10), (11), (12) & (13) to analyse collected samples (8). The collected samples' measurements can be recorded singly, simultaneously or in combinations thereof through controller (10). Additionally, different types of fluid receptacles may be used at anyone time or combinations thereof to determine a variety of environmental conditions within a particular site. The respective light consistent environment chambers are able to receive the differently shaped fluid receptacles accordingly. This flexibility allows for multitasking to be completed utilising just one Fluid analyser system with all work being carried out at the same time.

As shown in FIG. 10 a test is performed by starting up the equipment selecting the test type and collecting a sample of the fluid to be analysed in the receptacle. The test is then started and the temperature and optimally the humidity/dew point and atmospheric pressure are determined. The radiation detector(s) are then activated and a measurement of the fluid sample is taken over a pre-determined duration and recorded. According to the nature of the test several samples may be analysed or the sample may be subjected to several measurements. As FIG. 10 also shows the data storage allows for the capture of a wide range of additional data appropriate to the nature of the sample. For example if the analysis is of breath, perhaps for medical purposes, then the location (at work, at home, travelling etc) can be recorded as can (indoors, outdoors, underground). Similarly the climatic conditions can be recorded as can the exact date, time and location at which the sample was taken.

As shown in FIG. 10, the user/controller has the ability to install data into the fluid analyser system's database by means of downloading information, installing from a disc, and/or a user/controller inputting data. In addition each test result can be stored and is automatically tagged by the user's title of the test, date, time and GPS location. The test is preferably, but not necessarily, stored chronologically and externally either in a bank of information and/or a media format with the test tag stored internally on the fluid analyser storage database, also chronologically, for immediate access to the result externally, if agreed by all concerned. This process can be reversed if the end user so chooses alternatively data can be freely extracted to suit.

Preferably, provision is also made for smart card access and deny ability as shown in FIG. 10. That is a securing methodology for information considered confidential.

FIG. 11 illustrates how the information obtained by the analysis can be used as a health diary. For example the analyser may be provided with alarm indicators (referred to as traffic lights in FIG. 11), which are activated if unusual or dangerous fluids or quantities of fluids are detected. Furthermore, the analysis may be compared with previously stored personal data to enable any changes to be identified.

The information obtained can then be stored and tagged for subsequent use for instance in forensic operations. The results can also be compared with existing data. Alternatively the data can be interpreted to provide warnings of the presence of dangerous fluids, environmental changes leading to storms and earthquakes and other natural phenomena. Alternatively the data can be interpreted for medical purposes for the diagnosis of illnesses and the prescription of medicines as an advisory system. The information can also be used to give a particular signature to the source of the sample for example; the accuracy of the techniques of the present invention enables unique individual breath signatures to be obtained somewhat like an individuals DNA profile. Having a unique individual signature registered could be most useful in other areas such as security and personal identity ratification. Replicating the individual signature, that is specific fluids in their concentrations, will not be possible. The fluid analyser system may be used for the purpose of predictions. For example, indications from a trend or signature that a person may have an illness developing which could be prevented if identified at an early stage.

The Examples of additional data that may be stored include one or more of external data such as height, weight, age, body mass, body surface area, lung capacity, blood type, blood analysis including blood pressure, hydration levels, blood sugars, blood testosterone, blood oestrogen levels and cholesterol. Blood flow, chill factors, reflection, respiration rate, pulse, gender, ethnicity, posture, lifestyle, supplementary lifestyle, location, supplementary location, molecular size, molecular weight, gravity, activities and calorific values.

The fluid analyser system can be used for clinical studies. In a study of Asthma, as one example of many, there would be a qualitative and/or quantitative difference not only between asthmatics and non-asthmatics but also between asthmatics of differing clinical manifestation, or variation within an individual sufferer on occasions of different physiological status. In this way the fluid analyser system will not only have the ability to screen for the presence of certain fluids associated with diseases or illnesses, but be able to monitor severity and long term fluctuation. In addition to the clear clinical diagnostic potential, the fluid analyser system will also be able to analyse components in the environment which may trigger or increase the risk of certain conditions, such as sensitising agents and allergens important to atopic excema, and other respiratory illnesses.

Another benefit of the fluid analyser system is that it is able to provide the user with instant data. The resulting advisory status report can be understood and appreciated by a wider user group immediately preventing event driven courses of action and decision making creating a more proactive approach.

When the receptacle is to be used with the analyser system of co-pending United Kingdom Patent Application 0127913.2, the shape of the inflated receptacle should be such that it is a close fit within the chamber that provides the consistent light condition environment of the fluid analyser system. We prefer that the receptacle, upon inflation by the fluid is cylindrical. The valve and the materials from which the container is made should be such that the container cannot be expanded beyond its original/intended capacity due to inflation by the pressure of the sample of the fluid.

At the time of collection of the sample of the fluid to be analysed using the system of co-pending United Kingdom Patent Application 0127913.2, the temperature of the sample should be measured and recorded together with other significant information such as the humidity, atmospheric pressure and location. The receptacle may therefore be provided with a cavity within its walls, usually the base, into which a thermistor can be inserted to measure the temperature of the skin of the container. Due to the flexible nature of the sample bag, it allows the temperature probe to be inserted into the fluid sample without penetrating the skin of the sample bag. This, together with a measurement of the ambient temperature can be used to determine the temperature of the fluid sample. The location of the cavity can be such that a thermistor probe mounted on the inside surface of the receptacle container chamber (consistent light condition environment) into which the inflated container is placed fits into the cavity of the receptacle.

Most analysers rely upon sensors gathering information from within frictional flow rates of fluids. However, the analyser of co-pending United Kingdom Patent Application 0127913.2 works by collecting the fluid sample via a non-invasive methodology. In a preferred embodiment the invention is useful in a fluid analyser that is portable and may be used to analyse the samples taken at a remote location and to interact with other fluid analyser systems usually of the same manufacture. Allowing its use in a wide variety of environments and settings.

By using the fluid analyser system the user has the potential to determine through comparative analysis, for example, whether or not an athlete has been involved with performance enhancing drugs.

One of the primary uses is as a means of collecting and analysing fluid samples to detect and quantify specific compounds, or combination of compounds. The results generated can become markers. These markers will be known as signatures and can be used as overlays for comparative analysis by the users for status reports, acting as an advisory system only. Using the advisory data together with other outside information and technologies, the users can determine problems, diseases and illnesses, diagnosis, individual dosage, designer medication, warnings and alarms, standards and predictions, remedial actions and identify new fluids. The Fluid analyser system data can be made available to the end user within 1 minute.

Staged timing throughout a 24 hour day using multiple sample containers inserted within the controlled environment chambers for automatic monitoring of the climatic register of the atmosphere will record regular comparative data altered by time and the process variables within the current environment.

All data received from the fluid analyser system sensors can be either magnified and/or averaged via multiple sampling to a greater degree of accuracy.

The receptacle of the present invention is particularly useful in such systems.

The above may be operated via a specially designed, fully co-ordinated, computer driven software system to provide an advisory status report.

The system of co-pending United Kingdom Patent Application 0127913.2 preferably also includes a means for the measurement of the humidity and dew point of the sample and also means for determining the atmospheric pressure. These measurements can be used to further calibrate the detector and they can also be stored to enable these factors to be taken into account if and when the profile is compared with another sample. This may be the case when the analyser is used for fluid/emission analysis for health and environmental purposes. In a further preferred embodiment the system is provided with a GPS so that the date, time and location (altitude, longitude and latitude) of the position where the sample was taken can be recorded.

The analysers of co-pending United Kingdom Patent Application 0127913.2 employing the fluid receptacles of the present invention can detect the presence of a multitude of fluids in a sample and it can also detect the presence of fluids down to parts per billion and beyond. The fluid analysers have the benefit that it may be used at anytime by trained operators in most environments and conditions. Furthermore, the analyser system is versatile. For example, the sample may be taken in the receptacle of the present invention at one location and the scanning and analysis system may be used in the same or another location. The detection signal, either via a remote control or operator, may then be transferred to another location for magnification, analysis and/or storage or kept in the same location for magnification, analysis and/or storage. Data may also be received in the same manner and this data and any other stored data may be used for comparative purposes being checked against any previous or current internal and/or external test results.

Having been able to identify the fluids present with their volumes expressed as a percentage of the sample. We can therefore determine the many characteristics of the fluids, weights and sizes for example. This will help us construct a far greater picture and moving model of all fluids and their real time activities.

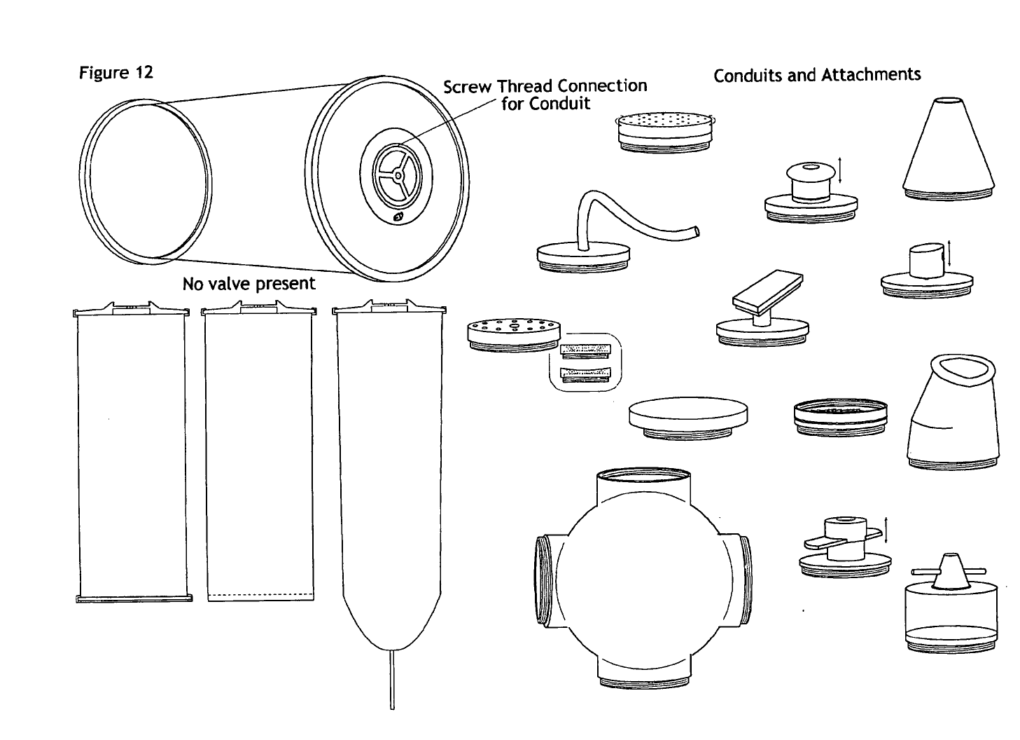

Although primarily useful for the collection of fluid samples for analysis, the receptacles as previously described can have other uses. FIGS. 12 to 19 illustrate further embodiments/attachments of the fluid receptacles of the present invention which render them useful for the following uses and/or storage of substances whether liquid, gaseous, powder, cream, gel, crystalline or solid and or any mixtures of all of same. For the single purpose/use or combinations of collecting, retrieving, separating, storing, transferring, injecting, pouring, spraying, mixing, applying, cooking, conserving, freezing, boiling, consuming, lubricating, transferring, vacuuming, inflating, filtering, dripping, heating, draining, dispensing, drinking, pumping, sealing, sterilising, measuring, shaking, part of a system or multiple systems for any or all of substances described. The receptacles can also draw in fluid without the need for fluid delivery means such as additional pumps and motors.

The walls of the receptacles of the present invention should be made of a material that is flexible but not elastic. The receptacle should also have a rigid top and optionally a rigid base which may be of different material from the materials of the walls. This enables the receptacle to be flat packed for delivery to the user. In this way considerable space and cost savings may be achieved as compared, for example, with the use of bottles as liquid containers. The lack of elasticity ensures that the receptacles can be filled with a known volume of material. It is also preferred that the walls of the receptacles are transparent to allow the contents to be viewed so that potential purchasers can inspect the contents and users can see how much of the contents remains in the receptacle. The material is preferably stable and inert and fluorocarbon polymers, such as polytetraflouorethylene, such as FEP, available from Du Pont, is preferred.

The receptacles will also be provided with means for introducing material into the receptacle and means to keep the material in the receptacle. These will depend upon the nature of the material but a non return valve is particularly useful when the materials are fluids particularly liquids. The receptacles will also be provided with means for releasing material from the receptacle which can be at the top and/or the base. The mechanism can be by applying pressure to the receptacle, by applying pressure to the liquid so that if flows out through a conduit by suction or by gravity for example in the dispensation of measures of liquid.

FIG. 12 is a representation but not limited to some applicators and connectors. Each applicator/connector can be attached to any type of fluid receptacle of the present invention. The attachment/conduit maybe fitted by means of a screw thread, a clip, a wedge, a plug or clamp among others.

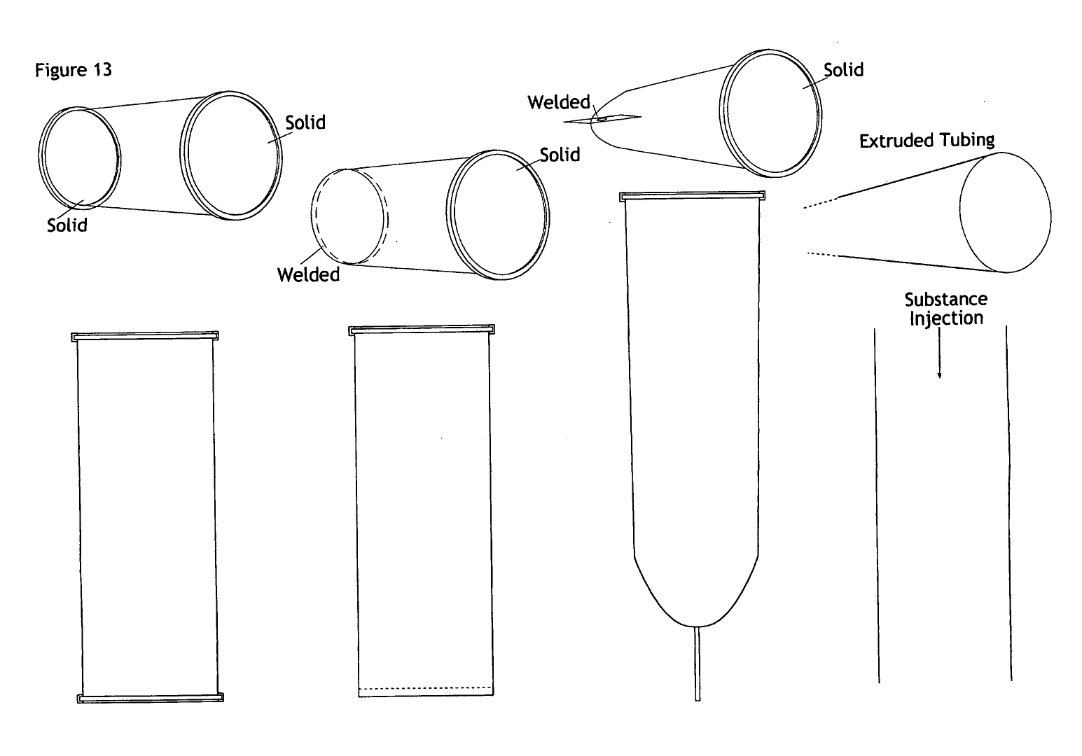

FIG. 13 illustrates how, in addition to the fluid receptacles already described, the receptacles can by way of different arrangement, become a ‘flexible can’ or container. FIG. 13 shows three containers with a rigid top and base, another with a flexible welded base and the third shows a bag. The substance/fluid can be encased within the fluid receptacle during manufacture/assembly or subsequently put in after and a tamperproof clip then applied. The receptacle may be opened by simply breaking the tamper proof clip at the top or the bottom and removing the lid.

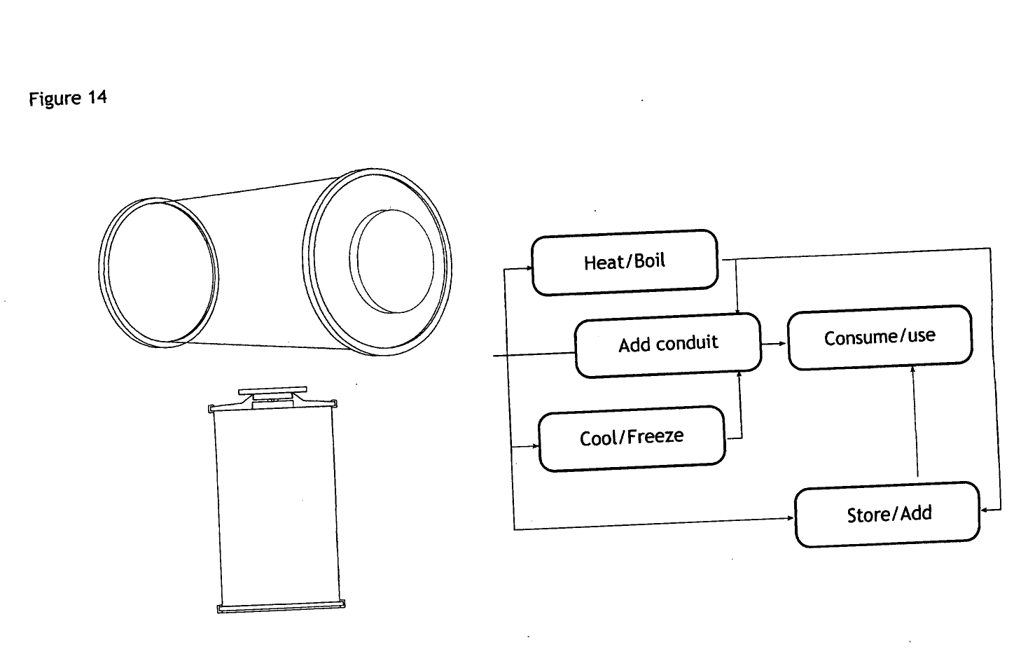

FIG. 14 illustrates how the fluid receptacles illustrated in FIGS. 1 to 7, 12 and 13 can be used for heating, cooling or maintaining a desired temperature for immediate use and/or storage. If required, appropriate applicators/conduits may be applied/attached as represented in FIG. 12.

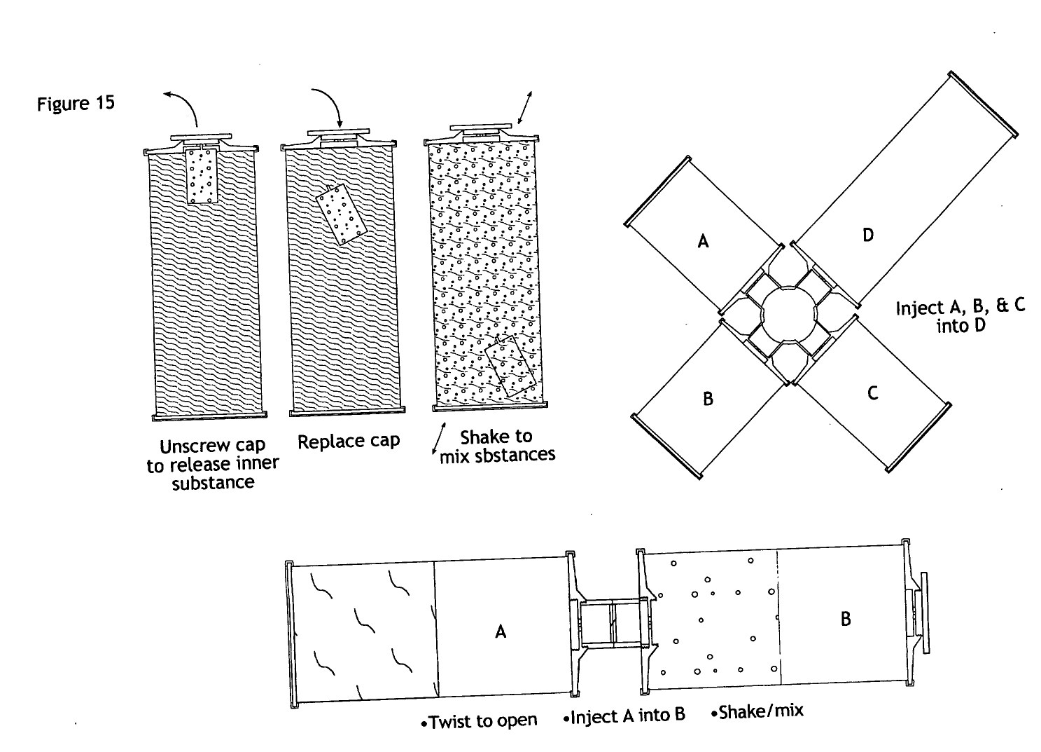

FIG. 15 illustrates three ways in which the fluid receptacles can be used to store individual or combinations of mixtures of fluids for subsequent mixing, use and/or storage.

FIG. 16 illustrates a method of packaging employing two receptacles that can protect and/or maintain the fluid/substance(s) contained within the inner receptacle. This may be used for temperature control, protection from light and the like. Any fluid/substance including air maybe inside the outer receptacle.

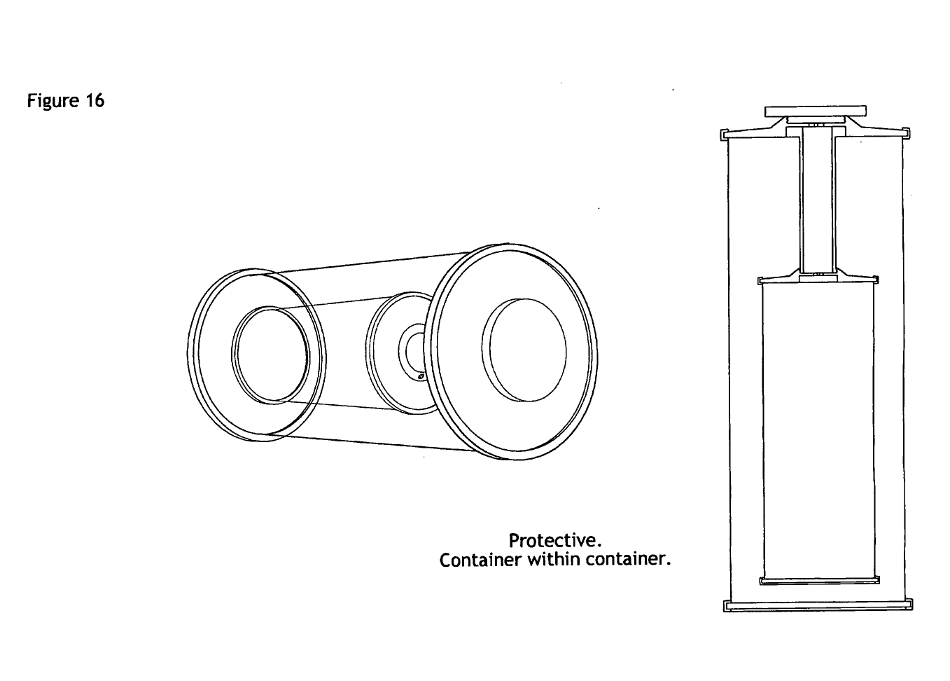

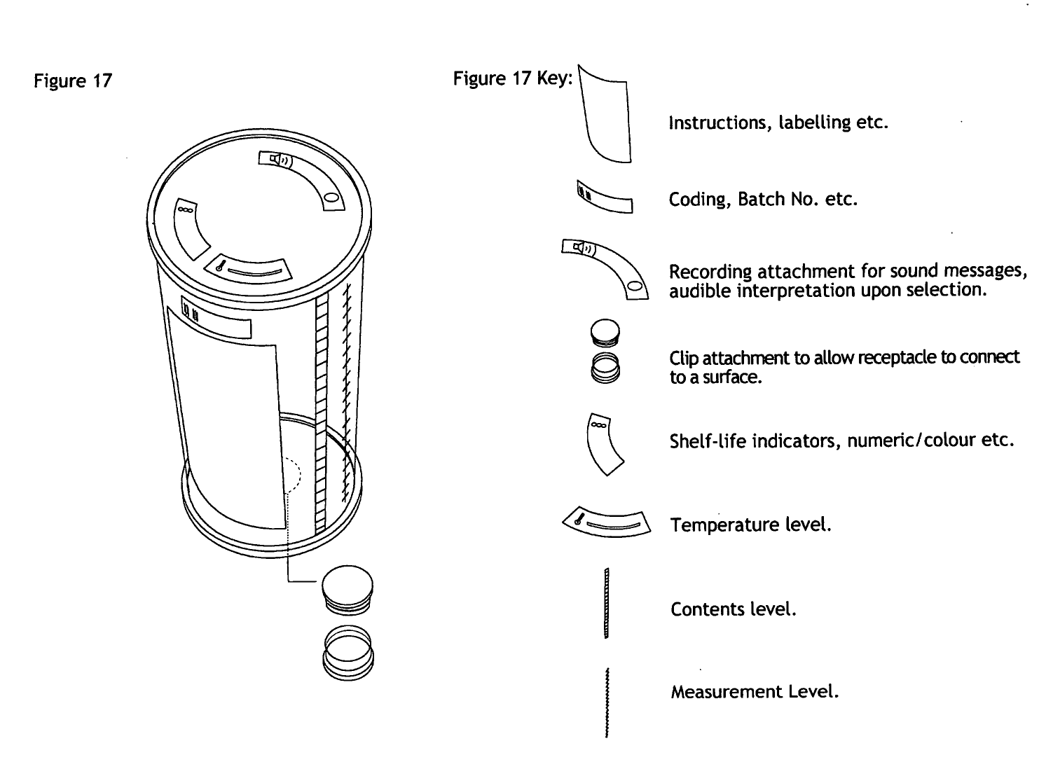

FIG. 17, illustrates ‘intelligent’ forms of receptacles that can provide information relating to the content or related information by the manufacturers/distributors and/or users by positioning/placing/printing/sticking the data and/or devices to the receptacle as shown. Any type of receptacle of the present invention maybe used or one or more of each type of information and not limited to FIG. 17. The location of each device on a receptacle is not important. For example FIG. 17 illustrates how instruction and labelling, coding and batch numbers, recording attachments, clips, shelf life indicators, temperature measurements, contents level measurement may be included. This is particularly useful when the walls are transparent.

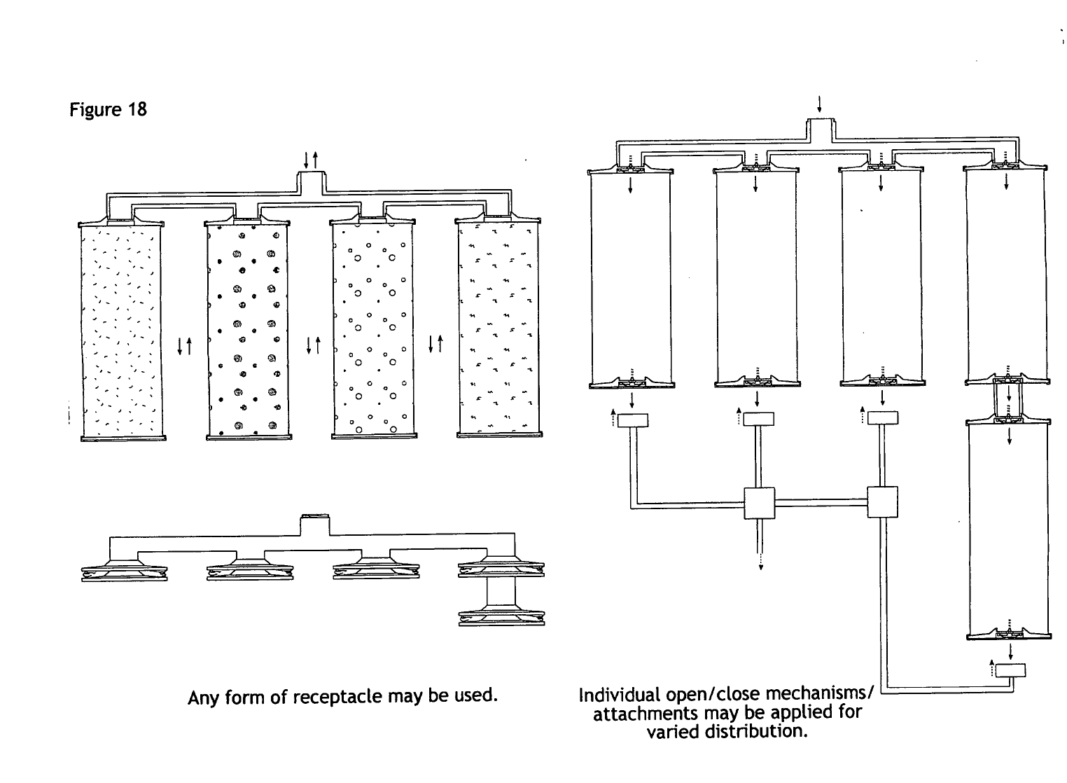

FIG. 18, illustrates a series of receptacles with release mechanisms and input valves which maybe used when filled to provide multiple mixing combinations and/or collect and/or store multiple samples of the same or similar source. The receptacles can be brought into operation at the same time or at different times to enable collection and/or release of a series of samples and with the same collected volume or different. FIG. 18 also shows the series of receptacles in uninflated form.

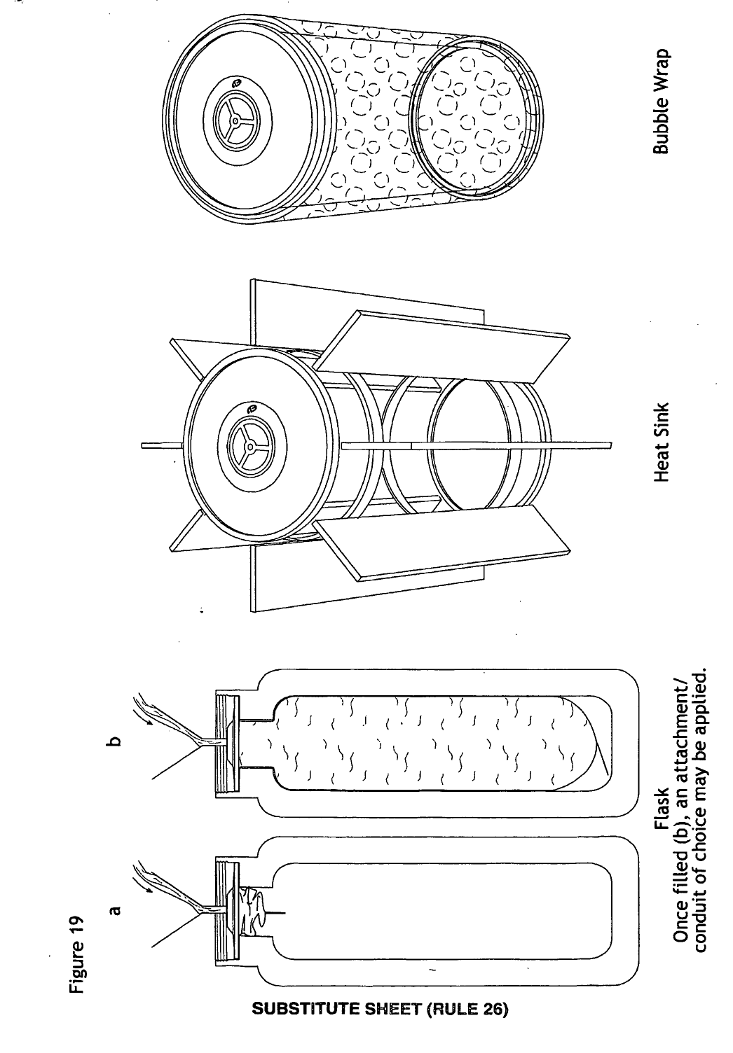

FIG. 19, illustrates how the receptacle can become part of a larger system or systems. For example, FIG. 19(a) and (b), is a receptacle being filled with a fluid/soup contained within a flask. Due to its nature the receptacle moulds around the shape of the flask interior as it is being filled. After the fluid has been used or consumed, the receptacle maybe disposed of and replaced for the next use thus obviating the need to clean the flask. FIG. 19 also shows how fins may be provided to hold the receptacle away from a substance or a surface and act as a heat sink by virtue of the fin. This embodiment can be used to provide temperature control. FIG. 19 further shows how the container and perhaps its delicate contents may be protected against damage.

The fluid receptacles maybe used/purchased empty or they maybe used/purchased with substances/fluids inside. Either way, use/purchase maybe individual, multiples of the same or combinations of different arrangements of fluid receptacles and/or attachments/conduits.

It is possible to disassemble the fluid receptacle, clean it and assemble for re-use, in the preferred form where no adhesives or resins are used recycling is enhanced as is re-use. However, the responsibility of this operation with regard to the integrity of the next fluid/substance contained within is down to the user.

The fluid receptacles provide a flexible combination of flat-packed, sterile, optically clear, inexpensive, versatile form of packaging that can be used in single or multiple systems or procedures that improves/maintains efficiency, quality and the integrity of the contents anywhere and at anytime. The receptacles when filled are also resistant to breakage upon impact.

1. A fluid receptacle that may be used for fluid analysis comprising a bag that may be inflated by the fluid, a non-return valve and a fluid delivery tube wherein the walls of the bag are of a material that is flexible, has high optical clarity and whose walls and/or base can receive a temperature measurement probe without penetrating the skin of the bag.

2. A receptacle according to claim 1 in which the side walls of the receptacle are flexible but not elastic.

3. A receptacle according to claim 1 which is flat packed and vacuum packed.

4. A receptacle according to claim 3 which has been sterilised.

5. A receptacle according to claim 1, wherein the walls are made from a fluorocarbon polymer.

6. A receptacle according to claim 1 comprising the sample bag, a non-return valve, a non-return valve holder, a tamperproof clip and a fluid delivery tube.

7. A receptacle according to claim 1, wherein the bag is extruded and sealed at one end by welding.

8. A receptacle according to claim 1, wherein the bag is provided with an opening into which the valve holder and valve can be sealed and the bag is secured to the valve holder.

9. A receptacle according to claim 1, wherein the valve holder is injection moulded.

10. A receptacle according to claim 1, wherein the valve and delivery tube are injection moulded.

11. A receptacle according to claim 1, wherein the valve holder, the valve and fluid delivery tube are of polypropylene.

12. A receptacle according to claim 1, wherein two or more receptacles are linked in series.

13. A receptacle according to claim 1, wherein the valve holder is shaped so that a fluid delivery tube can be attached to the top of the receptacle.

14. A receptacle according to claim 1, wherein the materials from which the container is made are such that the receptacle cannot be expanded beyond its original capacity due to inflation by the pressure of the sample.

15. A fluid analyser system comprising:
i) a consistent light condition environment in which the receptacle can be placed;
ii) a timing device for measuring duration of the scan of the radiation emitted by the fluid sample in the receptacle;
iii) a temperature sensor for determining the temperature of the sample;
iv) at least one detector for receiving data from the radiation emitted by the sample located at a predetermined distance from the sample; and
v) a device for translating and magnifying the signal from the detector enabling identification of the intensities and the peak intensity values' wavelengths;
of a receptacle for the fluid sample to be analysed that may be placed in the consistent light condition environment and comprising a bag that may be inflated by the fluid sample, a non-return valve and a fluid delivery tube wherein the walls of the bag are of a material that is flexible, has high optical clarity and whose walls and/or base can receive a temperature measurement probe without penetrating the skin of the bag.

16. The system according to claim 15 in which the shape of the inflated receptacle is such that it is a firm fit within the consistent light condition environment of the fluid analyser system.

17. The system according to claim 15 in which the receptacle upon inflation by the fluid to be analysed is cylindrical at the point where the radiation detectors are positioned.

18. A receptacle according to claim 1, wherein said base is a non-flexible base.

19. A receptacle according to claim 1, wherein said base is a flexible base.

20. A receptacle according to claim 1, wherein the bag is made from a single material.

21. A receptacle according to claim 1, wherein said receptacle maintains the integrity of the sample and requires no method of extraction or decanting for fluid analysis.

22. A receptacle comprising a transparent, flexible, inelastic bag having a rigid top and which comprises at least one additional component selected from the group consisting of:
a) A valve;
b) A valve holder;
c) A welded or flexible base;
d) A non-flexible base;
e) A tamperproof clip; and
f) An attachment/conduit and/or fluid delivery tube

23. A receptacle according to claim 22 provided with a tamperproof clip.

24. A receptacle according to claim 22, wherein said receptacle comprises conduits for attachments.

25. A receptacle according to claim 22, further comprising multiple ports to the inlet valves.

26. A receptacle according to claim 22, further comprising adaptors for simultaneous exit valve release on multiple chambers of said receptacle.

27. A receptacle according to claim 22, wherein said receptacle comprising multiple chambers wherein multiple samples of goods and fluids may be kept and extracted without disturbance of remaining stored samples.

28. A receptacle according to claim 22, wherein said receptacle is capable of receiving multiple exit conduits.

29. A receptacle according to claim 22, wherein said receptacle provides a multi chamber storage system.

30. A receptacle according to claim 22, wherein partial flow bypass fluid transfers of fluids can be performed without damaging the integrity of the fluids.

31. A receptacle according to claim 22, wherein the filled receptacle may be utilised as an internal liner to outer packaging.

32. A receptacle according to claim 22, wherein said receptacle is filled and disposed within another packaging material.

33. A receptacle according to claim 22, further comprising at least one item selected from the group consisting of: sell by date flags, alarms attached, bar codes etched, content level indicators applied temperature strips installed, verbal message pressure release buttons and advertising materials.

34. A receptacle according to claim 22, wherein the inelastic bag is a sealed extruded seamless tube.

35. A receptacle according to claim 22, wherein no resins or adhesives are used in the bag.

36. A receptacle according to claim 22, wherein said bag is formed of a fluorocarbon polymer.

37. A receptacle according to claim 22, wherein the walls of the bag are from 25 μm to 150 μm thick.

38. A receptacle according to claim 37 in which the walls are from 35 μm to 75 μm thick.

39. A method of using a receptacle for at least one use selected from the group consisting of: collecting, retrieving, separating, storing, transferring, injecting, pouring, spraying, mixing, applying, cooking, conserving, freezing, boiling, consuming, lubricating, transferring, vacuuming, inflating, filtering, dripping, heating, draining, dispensing, drinking, pumping, sealing, sterilising, measuring, and shaking.
